(19) United States
(12) Patent Application Publication
(10) Pub. No.: US 2023/0021962 A1
(43) Pub. Date: Jan. 26, 2023

(54) SUBSCRIPTION METRIC GENERATION FROM STORAGE-EFFICIENT SUBSCRIPTION CHARGE SEGMENT CHANGE LOGS

(71) Applicant: Zuora, Inc., Redwood City, CA (US)

(72) Inventor: Wei Liu, Beijing (CN)

(21) Appl. No.: 17/831,322

(22) Filed: Jun. 2, 2022

Related U.S. Application Data
(60) Provisional application No. 63/222,283, filed on Jul. 15, 2021.

(51) Int. Cl. G06Q 30/02

(52) U.S. Cl. CPC G06Q 30/0201; G06Q 30/0207

(57) ABSTRACT

A charge segment change log data model generates and stores subscription data in the form of charge segment change log records that require substantially less data storage capacity than a subscription versioning scheme employed in a subscription object model. The charge segment change log records utilize a data schema that enables an impact of amendments to a subscription to be readily determined directly from the change log records without requiring the cumbersome and performance-degrading comparison of contiguous subscription versions necessitated by the subscription object model.

### CROSS REFERENCE TO RELATED APPLICATION

This application claims the benefit of U.S. Provisional Application Ser. No. 63/222,283, entitled “Log-Based System For Accurately Reporting Subscription Booking Metrics,” filed on Jul. 15, 2021, which is incorporated by reference in its entirety herein.

### TECHNICAL FIELD

This disclosure pertains to multi-tenant computing environments, and more particularly, to charge segment change logs that enable efficient storage of subscription data and generation of subscription metrics therefrom in a multi-tenant computing system.

### BACKGROUND

A multi-tenant computing environment may provide cloud-based software-as-a-service (SaaS) services to multiple tenants, which may include, for example, service entities that provide services to end users on a subscription basis. The SaaS services provided by the multi-tenant computing environment may include billing services, data storage services, or the like that tenants can leverage in connection with their subscription-based service offerings. The multi-tenant computing environment may include a multi-tenant computing system that includes various types of shared resources for hosting the SaaS services. For any given tenant, there may be hundreds of thousands of active subscriptions across the tenant's end-user account holders.

Various changes may be made to a subscription over its lifetime. Such changes may modify one or more attributes of the subscription such as a product or service offering of the subscription, a duration of the subscription, and so forth. These changes may result in corresponding adjustments to subscription charges, which in turn, may result in changes to various subscription metrics such as monthly recurring revenue (MRR), total contract value (TCV), or the like. Determining how various changes to a subscription impact subscription metrics can become cumbersome, however, particularly when numerous changes are made to a subscription.

### SUMMARY

In an example embodiment, the present invention provides a method for generating subscription metrics from subscription data stored in a storage-efficient manner in a multi-tenant computing environment, the method comprising: receiving, at a metrics service of a multi-tenant computing environment, a request from an endpoint; determining one or more query parameters from the request; identifying subscription data corresponding to the one or more query parameters, the subscription data including charge segment change log records associated with a subscription charge of a subscription, each charge segment change log record including a delta value indicating an increase or decrease in the subscription charge for a corresponding charge segment time segment; calculating one or more subscription metrics relating to the subscription data based on the charge segment change log records; and returning a response to the endpoint that includes the one or more calculated subscription metrics.

Calculating the one or more subscription metrics may comprise calculating a recurring subscription metric for a particular time segment of the subscription charge, the particular time segment having a duration corresponding to a time period over which the recurring subscription metric is defined. Calculating the recurring subscription metric for the particular time segment may comprise identifying each charge segment change log record that corresponds to a respective charge segment time segment that includes the particular time segment; determining a respective delta value for each identified charge segment change log; and summing each respective delta value to obtain the recurring subscription metric for the particular time segment. The recurring subscription metric may be monthly recurring revenue (MRR) and the particular time segment may be a particular month of an overall time period during which the subscription is active. The method may further comprise receiving input indicating an amendment to the subscription; determining, from the received input, a time period over which the amendment to the subscription is applicable; determining, from the received input, an amount by which the subscription charge is changed by the amendment; and generating a new charge segment change log record comprising a corresponding charge segment time segment equal to the time period over which the amendment to the subscription is applicable and a corresponding delta value equal to the amount by which the subscription charge is changed by the amendment. The new charge segment change log record may further comprise an amendment type field, the method further comprising populating the amendment type field with a reason code identifying an attribute of the subscription modified by the amendment to the subscription. The amendment to the subscription may be a first amendment to the subscription, the new charge segment change log record may be a first new charge segment change log record, the reason code may be a first reason code, and the attribute of the subscription may be a first attribute of the subscription, the method further comprising determining that the received input indicates a second amendment to the subscription linked to the first amendment to the subscription; generating a second new charge segment change log record for the second amendment to the subscription, the second new charge segment change log record comprising the amendment type field; and populating the amendment type field of the second new charge segment change log record with a second reason code identifying a second attribute of the subscription modified by the second amendment to the subscription, wherein the second reason code is distinct from the first reason code. The charge segment change log records associated with the subscription charge may be ordered based on respective start dates of the corresponding charge segment time segments. Identifying the subscription data may comprise querying one or more back-end services of the multi-tenant environment for the subscription data. The method may further comprise determining a gross value of a recurring subscription metric for a particular time segment at least in part by summing a respective delta value of each charge segment change log record corresponding to a respective charge segment time segment that includes the particular time segment; identifying a first recurring discount and a second recurring discount to be applied to the subscription charge, the first recurring discount having a higher priority of application to the subscription charge than the second recurring discount, the first recurring discount being a fixed amount discount and the second recurring discount being a percentage discount; determining a first discount value for the particular time segment based on the first recurring discount; applying, based on the first recurring discount having a higher priority than the second recurring discount, the first recurring discount to the gross value of the recurring subscription metric for the particular time segment to obtain an intermediate value; applying the second recurring discount to the intermediate value to obtain a second discount value for the particular time segment; summing the first discount value and the second discount value to obtain a total discount value for the particular time segment; and subtracting the total discount value from the gross value of the recurring subscription metric to obtain a net value of the recurring subscription metric for the particular time segment. The subscription charge may be a first subscription charge, the gross value of the recurring subscription metric for the particular time segment may be a first gross value corresponding to the first subscription charge, the net value of the recurring subscription metric for the particular time segment may be a first net value corresponding to the first subscription charge, and the subscription may include a second subscription charge, the method further comprising determining that the first recurring discount is exhausted after determining the first discount value for the particular time segment for the first subscription charge; and applying only the second recurring discount to a second gross value of the recurring subscription metric corresponding to the second subscription charge for the particular time segment to obtain a net value of the recurring subscription metric corresponding to the second subscription charge for the particular time segment. The method may further comprising converting the charge segment change log records into corresponding metrics segments; generating a first visualization of the charge segment change log records, the first visualization including a graphical depiction of a respective delta value of each charge segment change log record extending across a respective charge segment time segment of the charge segment change log record; and generating a second visualization of the metrics segments, the second visualization including a graphical depiction of a respective value of a recurring subscription metric for each of multiple time segments that cumulatively span an overall time period during which the subscription is active.

In an example embodiment, the present invention provides a system of generating subscription metrics from subscription data stored in a multi-tenant computing environment. The system may comprising at least one memory storing computer-executable instructions; and at least one processor configured to access the at least one memory and execute the computer-executable instructions to: receive request from an endpoint; determine one or more query parameters from the request; retrieve subscription data corresponding to the one or more query parameters, the subscription data including charge segment change log records associated with a subscription charge of a subscription, each charge segment change log record including a delta value indicating an increase or decrease in the subscription charge for a corresponding charge segment time segment; calculate one or more subscription metrics relating to the subscription data based on the charge segment change log records; and return a response to the endpoint that includes the one or more calculated subscription metrics.

The at least one processor may be configured to calculate the one or more subscription metrics by executing the computer-executable instructions to calculate a recurring subscription metric for a particular time segment of the subscription charge, wherein the particular time segment has a duration corresponding to a time period over which the recurring subscription metric is defined. The at least one processor may be configured to calculate the recurring subscription metric for the particular time segment by executing the computer-executable instructions to: identify each charge segment change log record that corresponds to a respective charge segment time segment that includes the particular time segment; determine a respective delta value for each identified charge segment change log; and sum each respective delta value to obtain the recurring subscription metric for the particular time segment. The at least one processor may be further configured to execute the computer-executable instructions to: receive input indicating an amendment to the subscription; determine, from the received input, a time period over which the amendment to the subscription is applicable; determine, from the received input, an amount by which the subscription charge is changed by the amendment; and generate a new charge segment change log record comprising a corresponding charge segment time segment equal to the time period over which the amendment to the subscription is applicable and a corresponding delta value equal to the amount by which the subscription charge is changed by the amendment. The new charge segment change log record may further comprise an amendment type field, and the at least one processor may be further configured to execute the computer-executable instructions to populate the amendment type field with a reason code identifying an attribute of the subscription modified by the amendment to the subscription. The amendment to the subscription may be a first amendment to the subscription, the new charge segment change log record may be a first new charge segment change log record, the reason code may be a first reason code, and the attribute of the subscription may be a first attribute of the subscription, and the at least one processor may be further configured to execute the computer-executable instructions to: determine that the received input indicates a second amendment to the subscription linked to the first amendment to the subscription; generate a second new charge segment change log record for the second amendment to the subscription, the second new charge segment change log record comprising the amendment type field; and populate the amendment type field of the second new charge segment change log record with a second reason code identifying a second attribute of the subscription modified by the second amendment to the subscription, wherein the second reason code is distinct from the first reason code. The at least one processor may be further configured to execute the computer-executable instructions to: determine a gross value of a recurring subscription metric for a particular time segment at least in part by summing a respective delta value of each charge segment change log record corresponding to a respective charge segment time segment that includes the particular time segment; identify a first recurring discount and a second recurring discount to be applied to the subscription charge, the first recurring discount having a higher priority of application to the subscription charge than the second recurring discount, the first recurring discount being a fixed amount discount and the second recurring discount being a percentage discount; determine a first discount value for the particular time segment based on the first recurring discount; apply, based on the first recurring discount having a higher priority than the second recurring discount, the first recurring discount to the gross value of the recurring subscription metric for the particular time segment to obtain an intermediate value; apply the second recurring discount to the intermediate value to obtain a second discount value for the particular time segment; sum the first discount value and the second discount value to obtain a total discount value for the particular time segment; and subtract the total discount value from the gross value of the recurring subscription metric to obtain a net value of the recurring subscription metric for the particular time segment. The subscription charge may be a first subscription charge, the gross value of the recurring subscription metric for the particular time segment may be a first gross value corresponding to the first subscription charge, the net value of the recurring subscription metric for the particular time segment may be a first net value corresponding to the first subscription charge, and the subscription may include a second subscription charge, the method further comprising: determining that the first recurring discount is exhausted after determining the first discount value for the particular time segment for the first subscription charge; and applying only the second recurring discount to a second gross value of the recurring subscription metric corresponding to the second subscription charge for the particular time segment to obtain a net value of the recurring subscription metric corresponding to the second subscription charge for the particular time segment.

In an example embodiment, the present invention provides a method of storing subscription data in a multi-tenant environment, the method comprising receiving input indicating a change to a recurring subscription charge for a subscription; determining, from the received input, a time period over which the change to the recurring subscription charge is applicable; generating a charge segment change log record representative of the change to the recurring subscription charge, the charge segment change log record including a charge segment time segment corresponding to the time period over which the change to the recurring subscription charge is applicable and a delta value corresponding to an amount of the change to the recurring subscription charge; and appending the charge segment change log record to an existing set of one or more stored change log records associated with the subscription charge, the set of charge segment change log records including the appended charge segment change log record occupying less data storage capacity than a set of subscription versions, each subscription version representing a current state of the subscription after a corresponding change to the subscription and each prior state of the subscription.

Any of the above-described method, system, and/or computer program product embodiments can be combined in any manner to obtain additional embodiments of the disclosed technology. In particular, any feature, component, aspect, or the like of a given embodiment can be combined with any other feature, component, aspect, or the like of any other embodiment to obtain another embodiment of the disclosed technology.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the disclosed technology are set forth with particularity in the appended claims. A better understanding of the features and advantages of the disclosed technology will be obtained by reference to the following detailed description that sets forth illustrative embodiments, in which the principles of the technology are utilized, and the accompanying drawings of which:

FIG. 1 is a block diagram depicting an example network system that includes a multi-tenant system configured to provide cloud-based software-as-a-service (SaaS) services to multiple tenants in accordance with embodiments of the disclosed technology.

FIG. 2 is a block diagram depicting a system architecture that includes a metrics service configured to generate subscription metrics from charge segment change log records and return the subscription metrics in response to a query from an endpoint in accordance with embodiments of the disclosed technology.

FIG. 3 is a block diagram of an example change log object schema in accordance with embodiments of the disclosed technology.

FIG. 4 is a block diagram of a metrics calculation engine in accordance with embodiments of the disclosed technology.

FIG. 5A illustrates example charge segment change logs and corresponding metrics segments in accordance with embodiments of the disclosed technology.

FIG. 5B illustrates alternate types of visualizations that can be generated from a collection of charge segment change logs in accordance with embodiments of the disclosed technology.

FIG. 6 illustrates the application of a fixed discount and a percentage discount to a collection of subscription charges based on a predetermined priority in accordance with embodiments of the disclosed technology.

FIG. 7 illustrates tabular and graphical representations of subscription metrics in accordance with embodiments of the disclosed technology.

FIG. 8 graphically illustrates application of a recurring discount to a combination of recurring and one-time subscription charges in accordance with embodiments of the disclosed technology.

FIG. 9 graphically illustrates alternate representations of application of a recurring discount in accordance with embodiments of the disclosed technology.

FIG. 10 illustrates a process flow for migration of charge segment change logs from a billing service to a metrics service in accordance with embodiments of the disclosed technology.

FIG. 11 is a flowchart of an illustrative method for generating subscription metrics from charge segment change logs in accordance with embodiments of the disclosed technology.

FIG. 12 is a block diagram depicting an example computing device that may form at least part of a computing system configured to implement features disclosed herein in accordance with embodiments of the disclosed technology.

### DETAILED DESCRIPTION

A multi-tenant computing environment may include a multi-tenant computing system that includes various hardware and software resources configured to provide software-as-a-service (SaaS) SaaS services to multiple tenants. Such SaaS services may be provided within a microservices-based architecture according to which each service may be structured as a microservice configured to utilize/communicate with other microservices via corresponding service provider interfaces (SPIs). Data may be exchanged between microservices via their corresponding SPIs.

The multi-tenant computing environment may store respective tenant data for each of the multiple tenants that utilize its services. Tenant data for a given tenant—which may include, without limitation, account holder/subscription data such as subscriber billing/payment data, subscriber account profile data, or the like—may be stored across multiple data stores and/or within multiple data environments. As such, tenant data relating to any given tenant may be viewed as a logical grouping of disparate but interrelated data across multiple services.

Various types of data object models may be employed to store tenant data such as subscription data. These different data object models may produce subscription data of varying sizes for a given set of subscriptions, and as such, may require different data storage capacities. For instance, a subscription object model may be employed according to which a new subscription object instance (referred to herein as a subscription version or subscription snapshot) may be generated in response to each change to a subscription (also referred to herein as an amendment). According to such a subscription object model, each subscription snapshot may represent a snapshot of the subscription at the time that the subscription snapshot is generated and may contain the cumulative subscription details of all prior subscription versions.

For example, in the subscription object model, when a subscription is first created with an associated subscription charge (or a new subscription charge is added to an existing active subscription), a corresponding subscription snapshot may be generated that includes data indicating the amount of the recurring subscription charge (e.g., $10 per month) and the time period over the which the subscription charge is to be billed to an owner of the subscription (e.g., an account holder/subscriber of a given tenant). Thereafter, with each change/amendment made to the subscription, a new subscription snapshot may be generated that consolidated therein the data reflecting the change to the subscription (e.g., an increase or decrease in the recurring subscription charge) as well as a timeframe over which the altered subscription charge is applicable. The newly generated subscription snapshot further includes data indicative of the prior versions of the subscription, such as data reflecting prior amounts of the subscription charge and time periods over which those prior subscription charge amounts were applied.

For instance, an initial subscription snapshot may include data reflecting a subscription charge of $10 per month for a time period beginning on Jan. 1, 2021 and ending on Jun. 1, 2021. Thereafter, a change to the subscription may be made on Feb. 1, 2021. The change may be, for example, an addition or deletion of a product or service offering, which may modify the subscription charge amount. For example, the change may result in the subscription charge increasing from $10 per month to $15 per month, and the change may be effective from Feb. 1, 2021 through the end of the subscription period (i.e., Jun. 1, 2021). A new subscription snapshot may be generated that includes data reflecting the increased subscription charge amount of $15 per month as well as the timeframe over which the modified subscription charge is applicable (i.e., Feb. 1, 2021 to Jun. 1, 2021). This new subscription snapshot also includes data reflecting subscription details of the prior initial subscription snapshot, in this case, the prior subscription charge amount of $10 per month and the timeframe over which that prior subscription charge amount was applied (i.e., Jan. 1, 2021 to Feb. 1, 2021).

Thereafter, yet another amendment may be made to the subscription on Mar. 1, 2021. For example, a product/service offering may be removed from the subscription, resulting in a decrease in the subscription charge from $15 per month to $12 per month. A corresponding new subscription snapshot may then be generated that includes data reflecting the updated subscription charge amount of $12 per month and the time period over which this new subscription charge amount is applicable (i.e., Mar. 1, 2021 to Jun. 1, 2021). As described earlier, this latest subscription snapshot may reflect a current state of the subscription, but also includes data reflecting prior subscription states including the subscription charge amount of $10 per month applicable from Jan. 1, 2021 to Feb. 1, 2021 and the subscription charge amount of $15 per month applicable from Feb. 1, 2021 to Mar. 1, 2021.

As the above example illustrates, as the number of amendments made to a subscription increases, so too does the size of the subscription data contained in each new subscription snapshot that is generated responsive to the subscription amendments. In particular, as noted earlier, in the subscription object model, a new subscription snapshot generated in response to a corresponding subscription amendment includes not only subscription data indicative of the changes to the subscription that prompted the new subscription snapshot, but also subscription data indicative of prior versions of the subscription. Thus, with each new subscription change, the content embodied in the new subscription snapshot that is generated continues to grow in size. Moreover, in at least some cases, prior subscription snapshot continue to be maintained, requiring even further data storage capacity.

In addition to the above-noted data storage problem, the subscription object model can also pose a technical problem with respect to evaluating the impact of a subscription amendment on certain types of subscription metrics. In particular, while the subscription object model may lend itself with relative ease to generating certain types of subscription metrics such as monthly recurring revenue (MRR) or total contract value (TCV) as of a certain point in time, the model does not easily enable ascertaining the revenue impact of a given amendment over the course of a subscription. For instance, if a product or service is removed from a subscription—thereby causing a reduction in a recurring subscription charge—ascertaining the revenue impact of that amendment from the corresponding subscription snapshot (e.g., determining the amount by which monthly revenue is reduced due to removal of the product/service) is difficult. In some cases, contiguous snapshots of a subscription in a subscription object model could be compared at runtime to determine the revenue impact of such an amendment. For instance, if a product/service costing $10 per month is removed in subscription snapshot 2, by comparing subscription snapshot 2 with subscription snapshot 1, it can be determined that the revenue impact of the subscription change is −$10 per month. However, this contiguous subscription snapshot comparison and calculation is done on-the-fly and can exhibit poor performance, particularly when a subscription contains numerous snapshots and subscription charges.

Embodiments of the disclosed technology relate to a charge segment change log data model that provides technical solutions to the above-described technical problems associated with a subscription object model, as well as, systems, methods, and computer-readable media for implementing the charge segment change log data model. A charge segment change log data model according to embodiments of the disclosed technology generates and stores subscription data in the form of charge segment change log records that require substantially less data storage capacity than the subscription versioning scheme employed in the subscription object model. Further, the charge segment change log records utilize a data schema that enables the revenue impact of amendments to a subscription to be readily determined directly from the change log records without requiring the cumbersome and performance-degrading comparison of contiguous subscription versions necessitated by the subscription object model. Moreover, the charge segment change log data model achieves these technical benefits without sacrificing the capability to calculate subscription metrics from the change log records with relative ease.

Referring again to the example introduced earlier, but this time in the context of the charge segment change log data model disclosed herein, a charge segment change log record may be generated to represent the subscription charge of $10 per month for the time period beginning on Jan. 1, 2021 and ending on Jun. 1, 2021. More generally, a new charge segment change log record may be generated each time a subscription/subscription charge is created or amended. Each charge segment change log record may include a charge segment time segment and a delta value. The time segment of the change log record may be defined by a start date and an end date and may represent a time period over which a subscription amendment embodied by the change log record is applicable. The delta value may represent an amount by which a subscription charge is modified by the subscription amendment.

For instance, the change log record generated responsive to the creation of a subscription from Jan. 1, 2021 to Jun. 1, 2021 with a subscription charge of $10 per month may be represented as [1/1, 6/1, +10]. Then, when the subscription is modified on Feb. 1, 2021, resulting in the subscription charge increasing from $10 per month to $15 per month, a new change log record may be generated with a charge segment time segment from Feb. 1, 2021 to Jun. 1, 2021 and a delta value of +5 that represents the amount of the increase in the subscription charge. This new change log record may be represented as [2/1, 6/1, +5] and may be appended to the previously generated change log record [1/1, 6/1, +10]. As used herein, appending a change log record to an existing set of one or more change log records may include any mechanism by which the change log records corresponding to a particular subscription/subscription charge are ordered to reflect a sequence in which amendments to the subscription/subscription charge are made. When the subscription is again changed—lowering the subscription charge from $15 to $12—yet another change log record may be generated, represented, for example, as [3/1, 6/1, −3]. This newest change log record may be similarly appended to the previously generated change log records. Thus, the three subscription amendments in this example may be collectively represented by the set of change log records: {[1/1, 6/1, +10]; [2/1, 6/1, +5]; [3/1, 6/1, −3]}. It should be appreciated that the syntactical representations of change log records provided herein, including representations depicted in the Figures, are merely illustrative and not limiting.

Storing the above set of change log records requires significantly less data storage capacity than would be required for storing a set of subscription snapshots for the same set of subscription amendments. Thus, the change log data object model disclosed herein that utilizes change log records provides a more storage-efficient framework for handling subscription data than the subscription object model that relies on subscription versioning. Not only are change log records a more storage-efficient mechanism for representing subscription data than subscription snapshots, they also do not result in the loss of any information relating to changes made to a subscription. In particular, any subscription metric capable of being calculated from data contained in a subscription snapshot under the subscription object model can similarly be calculated from data contained in the change log records of the change log object data model. For instance, MRR on Mar. 1, 2021 for the subscription charge in the example introduced above can be determined by summing the respective delta values for each change log record having a charge segment time segment that encompasses that date, i.e., summing the delta values of all the change log records (10+5−3=12). Moreover, as previously described, the charge segment change log data model disclosed herein enables the revenue impact of a given subscription amendment to be readily determined directly from the change log records themselves. For instance, the revenue impact of the amendment on Mar. 1, 2021 can be readily determined as −3 from the change log record [3/1, 6/1, −3], and the TCV impact of the amendment can be easily calculated as −3*3=−9 (−$3 for three months).

An overview of various embodiments of the disclosed technology has been presented above. A more detailed discussion of these and other embodiments of the disclosed technology will now be provided. It should be appreciated the any embodiments individually described herein can be combined in any manner to yield additional embodiments of the disclosed technology. It should further be appreciated that discussion herein of one or more aspects of any particular embodiment shall not be construed as an admission that such aspect(s) are not also shared by other embodiments of the disclosed technology.

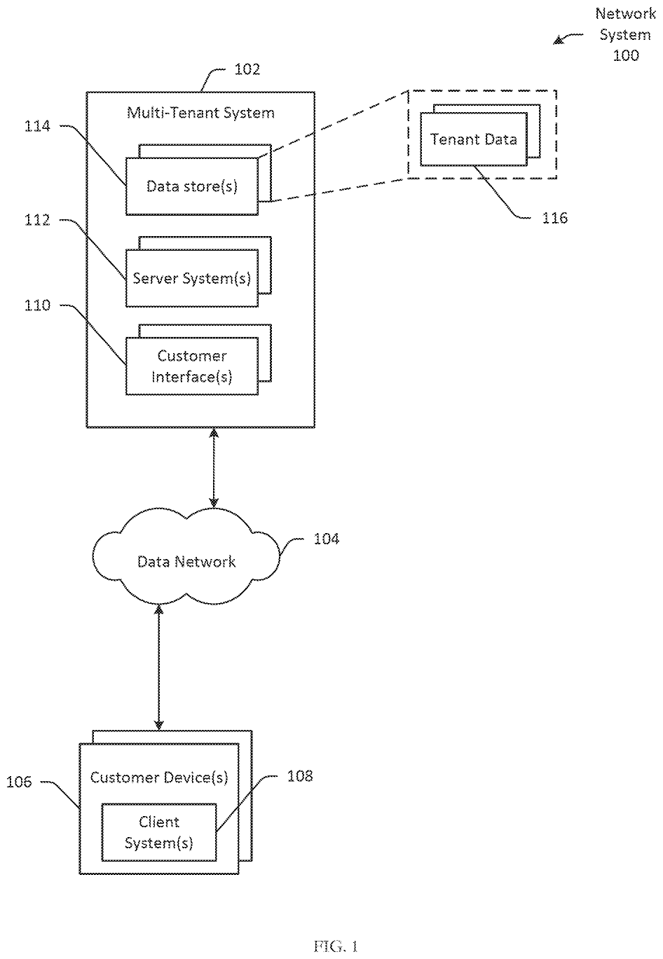

FIG. 1 depicts a diagram of an example network system 100 for providing cloud-based SaaS services of a multi-tenant system 102 to multiple tenants according to example embodiments of the disclosed technology. Examples of such cloud-based SaaS services include data storage services, data processing services, and business-oriented application services. In some embodiments, each tenant may be a subscription-based entity or provider such as an internet service provider, a home security system and service provider, a cellular phone service provider, an entertainment content provider, or the like. A respective group of one or more users (e.g., individuals, business entities, customers of the business entities, systems, etc.) may share access to the cloud-based services provided to each tenant by the multi-tenant system 102. In some embodiments, a tenant corresponds to a service entity such as AT&T™, Netflix™, Verizon™, or the like, and includes one or more products or services offered by an entity. For example, in an example embodiment, AT&T internet products and AT&T security products may be separate and distinct tenants. In some embodiments, the cloud-based SaaS services relate to managing subscriber records, product and/or service consumption information, billing information, payment information, or the like.

The network system 100 includes the multi-tenant system 102 coupled via a data network 104 (e.g., a set of one or more public and/or private, wired and/or wireless networks) to client/customer devices 106. The multi-tenant system 102 includes shared resources for hosting the cloud-based SaaS services provided to the tenants. The shared resources may include processors, memory, virtual systems, services, application programs, load balancers, firewalls, and so forth. As depicted in FIG. 1, the multi-tenant system 102 may include tenant/customer interfaces 110, server systems 112, and data stores 114. Each of the client devices 106 may include a client system 108 that accesses the cloud-based SaaS services hosted by the multi-tenant system 102. In some embodiments, the client systems 108 may be operated by employees (e.g., administrator users) of the provider of the multi-tenant system 102; by employees of the tenants; and/or by end users of the tenants' services.

Each client device 106 may include a personal computing device such as a desktop computer, a laptop computer, a notebook, a tablet, a personal digital assistant (PDA), a smartphone, a wearable computing device, and/or any other consumer electronic device incorporating one or more computer components. The client system 108 on each client device 106 may include hardware, software, and/or firmware for communicating with the multi-tenant system 102 and accessing the cloud-based services hosted by the multi-tenant system 102. Examples of the client systems 108 may include, without limitation, web browsers, client engines, drivers, user interface components, proprietary interfaces, and so forth.

The multi-tenant system 102 may include hardware, software, and/or firmware for hosting cloud-based services for tenants. In embodiments, the multi-tenant system 102 may offer access to shared resources including systems and applications on shared devices and may offer each tenant the same quality of service or may offer different tenants varying qualities of service. In some embodiments, the multi-tenant system 102 may not use virtualization or instantiation processes. In some embodiments, the multi-tenant system 102 may integrate several business computing systems into a common system with a view toward streamlining business processes and increasing efficiencies on a business-wide level.

In some embodiments, the multi-tenant system 102 includes a user interface tier of multiple tenant interfaces 110, a server tier of multiple server systems 112, and a data store tier of multiple data stores 114 for the multiple tenants. In some embodiments, the tenant interfaces 110 may include graphical user interfaces and/or web-based interfaces to enable tenants (e.g., users acting on behalf of tenants) to access the shared services hosted by the multi-tenant system 102. The tenant interfaces 110 may support load balancing when multiple tenants (and/or multiple customers of the tenants) attempt to access the multi-tenant system 102 concurrently. The tenant interfaces 110 may additionally or alternatively include an operator interface for use by a systems operator to configure or otherwise manage configuration settings or the like for the multi-tenant system 102. In some embodiments, to support load balancing, each tenant may be associated with a subset of the total number of tenant interfaces 110.

In some embodiments, the server systems 112 may include hardware, software, and/or firmware configured to host the shared services for tenants. The hosted services may include tenant-specific business services or functions, including enterprise resource planning (ERP) services; customer relationship management (CRM) services; eCommerce services; Human Resources (HR) management services; financial services including, for example, payroll services, accounting services, subscription billing services, financial reporting and analysis services, or the like; calendaring services; order processing services; inventory management services; supply chain management (SCM) services; collaboration services; sales force automation (SFA) services; marketing automation services; support services including, for example, contact list management services, call-center support services, web-based customer support services, or the like; partner and vendor management services; product lifecycle management (PLM) services; and so forth. Similar to the tenant interfaces 110, in some embodiments, the server systems 112 may support load balancing when multiple tenants (and/or multiple subscribers of tenants) attempt to access the multi-tenant system 102 concurrently. Further, in some embodiments, each tenant may be associated with a subset of the total number of server systems 112 to support load balancing.

In some embodiments, tenant data 116 for each tenant may be stored in a logical store across one or more physical data stores 114. In some embodiments, each tenant uses a logical store that is not assigned to any predetermined data stores 114. Each logical store may contain tenant data 116 that is used, generated, and/or stored as part of providing tenant-specific business services or functions. In some embodiments, the data stores 114 may include RDBMS, object-based database systems, or the like. In some embodiments, tenant data 116 may be stored across multiple data stores 114, with each data store dedicated to a particular service (e.g., managing customer records, managing product and/or service consumption information, managing billing information, managing payment information, etc.).

In some embodiments, the tenant data 116 may include subscription information, such as billing data and/or subscription status data (e.g., active, canceled, suspended, re-activated). Billing data may include billing invoice data (e.g., date of invoices and invoice amounts, overage charge dates and overage charge amounts, etc.); payment transaction data (e.g., date of payments, amount of payments, etc.); subscription charge/payment plan data such as subscription charge amounts, periodic billing information (e.g., annual billing, monthly billing, etc.), or the like; and/or service plan data (e.g., the name of a service plan). Subscription information may also include a geographic region and/or location information associated with a tenant, service, and/or subscriber. In some embodiments, the tenant data 116 may include usage data (e.g., account activity data), such as data identifying new subscriptions; changes to subscribed products and/or services; cancellation of one or more products and/or services; subscriptions to new products and/or services as part of an existing subscription; application of discounts; loyalty program package changes (e.g., additional programs and/or services, special rates, or the like for loyal customers); reduction or increase in rates for products and/or services; and/or cancellation of a subscription. In some embodiments, account activity data may include data indicative of subscriber product usage data (e.g., what channels the subscriber actually watches, what services and what level of consumption the subscriber receives, quality of the product and/or services, etc.). The tenant data 116 associated with a given tenant may include data at the tenant level such as subscription/product offering data, terms and conditions data, or the like that is generally applicable across subscribers of the tenant. The tenant data 116 associated with a given tenant may further include data at the individual subscriber/account holder level such as user profile/subscription data, user preference data, payment-related data (e.g., stored payment methods, billing history, etc.), and so forth.

In some embodiments, the tenant data 116 may be stored in one or more data formats according to one or more data schemas. For example, subscription tenant data may be stored in a particular format and usage tenant data may be stored in another format. As used herein, data formats, or simply formats, may include data types; variable types; file formats; protocols (e.g., protocols for accessing, storing, and/or transmitting data); programming languages; scripting languages; data value parameters (e.g., date formats, string lengths, etc.); endpoint locations; and so forth. In some embodiments, the tenant data 116 may be stored as data objects as part of an object-oriented data schema. The tenant data 116 may include parent data objects, where each parent data object is related to one or more child data objects via a parent-child dependency relationship. Any given parent data object may, in turn, be a child data object to one or more other parent data objects. Similarly, any given child data object may, in turn, be a parent data object to one or more other child data objects. In some embodiments, the tenant data 116 may include tabular data including one or more database tables and corresponding tabular data contained therein. Tabular data of the tenant data 116 may be linked to corresponding object data of the tenant data 116. The tenant data 116 may be formatted in accordance with one or more data models, which may define a structure/syntax/data schema for the data.

In some embodiments, the multi-tenant system 102 functions to provide uniform access to disparate services (e.g., microservices) and/or disparate data stores. For example, different services of the multi-tenant system 102 may manage (e.g., create, read, update, delete) tenant data 116 stored in different data stores 114. It will be appreciated that as used herein, a “service” may be single service and/or a set of services (e.g., a cluster of services). The data stores 114 may store data in different formats and/or the services may handle data differently. The services may each include a service provider interface (SPI) that provides data from the service and/or that receives data at the service in a common (or uniform) format, regardless of the original format that may be used by the service and/or data stores 114. In some embodiments, the multi-tenant system 102 may define a uniform access specification that defines the common format that the services must comport with when receiving and/or providing data. Accordingly, each of the services may be accessed in a uniform manner, and data may be consumed from the services in a uniform manner, regardless of the internal specifications and/or operations of the service.

The data/communication network 104 may represent one or more types of computer networks (e.g., a local area network (LAN), a wide area network (WAN), etc.) and/or underlying transmission media. The data network 104 may provide communication between the systems, engines, data stores, components, and/or devices described herein. In some embodiments, the data network 104 includes one or more computing devices, routers, cables, buses, and/or other network topologies (e.g., mesh network topologies). In some embodiments, the data network 104 may include one or more wired and/or wireless networks. In various embodiments, the data network 104 may include the Internet, one or more WANs, one or more LANs, and/or one or more other public, private, Internet Protocol (IP)-based, and/or non-IP-based networks.

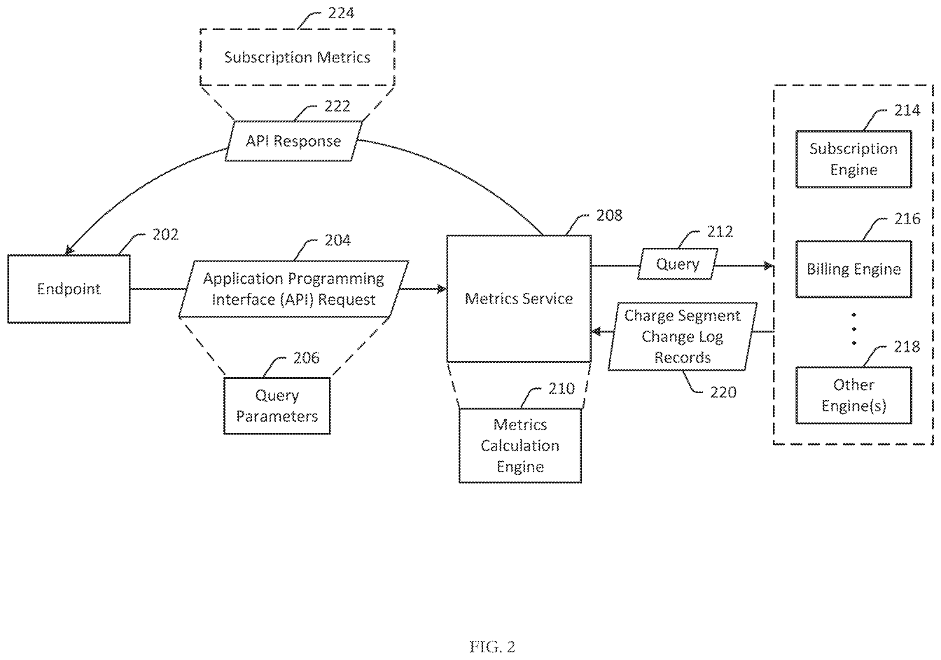

FIG. 2 is a block diagram depicting a system architecture that includes a metrics service configured to generate subscription metrics from charge segment change log records and provide the subscription metrics to a requesting endpoint 202 in accordance with embodiments of the disclosed technology. The endpoint 202 may be, for example, a customer device 106 utilized by a representative of a tenant (e.g., a tenant employee) to access subscription metrics associated with the cloud-based SaaS services provided by the multi-tenant system 102 to the tenant. As another non-limiting example, the endpoint 202 may be a subscriber's device that an account holder/subscriber utilizes to access subscription metrics associated with one or more of the account holder's subscriptions.

In some embodiments, the endpoint 202 may generate and submit an application programming interface (API) request 204 to the multi-tenant system 102, or more specifically, to a metrics service 208 of the multi-tenant system 102. The API request 204 may include one or more query parameters 206 for querying the metrics service 208 and/or one or more back-end services for subscription data, or more specifically, for subscription metrics calculated from subscription data associated with one or more subscriptions. If multiple types of query parameters are provided, they may be semantically combined with an AND operator. Further, the API request 204 may include any headers that may be needed for authentication and/or request tracing purposes.

In some embodiments, the query parameters 206 may include a subscriptionNumber query parameter specifying an identifier of a subscription for which subscription metrics are desired. The identifier may be an auto-generated value uniquely identifying a particular subscription. Multiple subscription identifiers may be provided and may be delimited by a comma or other delimiter, in which case, subscription data/metrics corresponding to the multiple subscriptions may be returned. In some embodiments, the response to the API request 204 may return subscription data/metrics corresponding to only a current state of the subscription. In other example embodiments, the API request 204 may specify startDateAlignTo and endDateAlignTo optional query parameters that define a time period over which subscription data/metrics are requested for one or more subscriptions.

In some embodiments, the query parameters 206 may include an accountNumber query parameter. The accountNumber query parameter may be a subscriptionOwnerAccountNumber query parameter or an invoiceOwnerAccountNumber query parameter, which may be identifiers that uniquely identify a subscription owner account and a subscription invoice owner account, respectively. In some embodiments, the API request 204 may include a subscriptionNumber parameter, or in the alternative, an accountNumber parameter, allowing for a query to be performed by account, or in the alternative, by subscription, but may return an error if both types of parameters are provided in the API request 204.

In some embodiments, the query parameters 206 may further include one or more metric parameters indicative of one or more subscription metrics requested in relation to one or more subscriptions. Metric query parameters may include any of a variety of subscription/booking metrics (collectively referred to herein as subscription metrics) including, without limitation, MRR; quantity; derived metrics such as annual recurring revenue (ARR), net MRR, or net ARR; TCV; monthly contract value (MCV); and/or derived metrics such as annual contract value (ACV), list MCV/ACV, or the like. Multiple metric query parameters may be specified, in which case, the multiple parameters may be separated using a delimiter such as a comma (e.g., “MRR, TCV”). In some embodiments, a default metric query parameter may be used if no metric parameter is explicitly provided in the API request 204. The query parameters 206 may further include an optional cursor parameter for cursor-based pagination. In particular, if an API response 222 returned in response to the API request 204 includes multiple pages, then the response 222 may also include a cursor value, which can be used as the input to the next API call to retrieve the next page.

In some embodiments, a metrics service 208 may receive the API request 204 and identify/retrieve the query parameter(s) 206 included therein. The metrics service 208 may be implemented as one or more micro-services of the multi-tenant system 102. In some embodiments, the metrics service 208 may provide a subscription metric generation service that is distinct from SaaS services provided by other components of the multi-tenant system 102. For instance, the subscription metric generation/calculation service provided by the metrics service 208 may be distinct from subscription management services provided by a subscription engine 214, billing-related services provided by a billing engine 216, or other services provided by other engine(s) 218. It should be appreciated that the subscription engine 214, the billing engine 216, and/or the other engine(s) 218 may themselves also be implemented as one or more respective micro-services.

In some embodiments, the metrics service 208 may query one or more of the back-end engines (e.g., the subscription engine 214, the billing engine 216, and/or other engine(s) 218) for subscription data relating to the query parameters 206 in the API request 204. More specifically, in some embodiments, the metrics service 208 may generate a query 212 based on the query parameters (e.g., a SQL query), and may send the query 212 to one or more of the back-end engines to retrieve corresponding subscription data, which may take the form of a collection of charge segment change log records 220. A metrics calculation engine 210 of the metrics service 208 may then proceed to calculate one or more subscription metrics from the change log records 220.

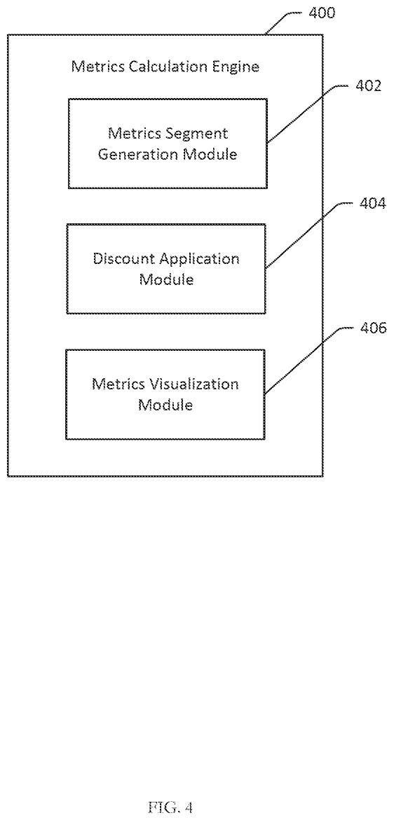

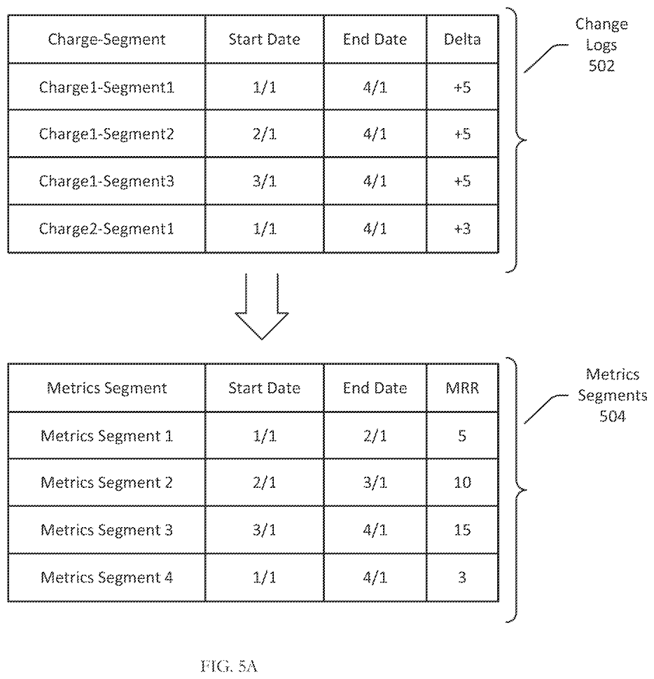

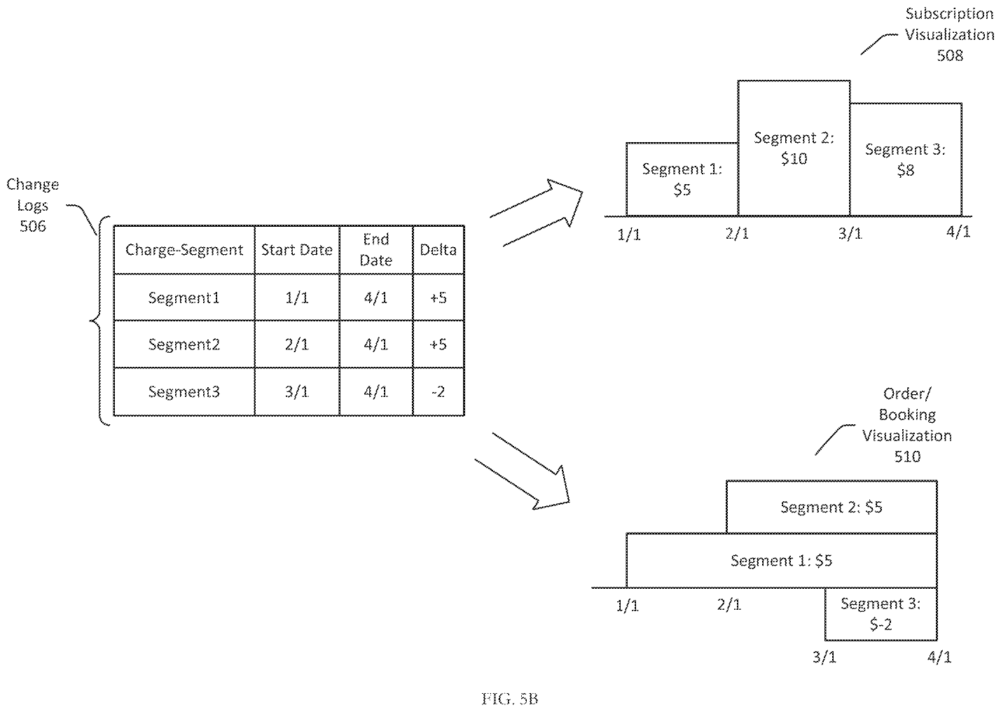

FIG. 4 depicts a particular implementation 400 of the metrics calculation engine 210. The metrics calculation engine 400 includes a metrics segment generation module 402, a discount application module 404, and a metrics visualization module 406. As previously noted, the metrics service 208, including the metrics calculation engine 210 and its various modules, may be housed in the multi-tenant system 102, or more specifically, in one or more server systems 112 of the multi-tenant system 102. In some embodiments, one or more processors of one or more server systems 112 of the multi-tenant system 102 may execute machine-executable instructions of the metrics calculation engine 400 to calculate the one or more subscription metrics from the change log records 220. In some embodiments, calculating the subscription metric(s) from the change log records 200 may include executing machine-executable instructions of the metrics segment generation module 402 to generate metrics segments from the change log records 220. Calculating the metrics segments from the change log records may include summing the respective delta values of various change log records to obtain a subscription metric (e.g., MRR) for a particular time segment. Calculation of subscription metrics from change log records vis-à-vis metric segment generation will be described in more detail later in this disclosure in reference to FIG. 5A.

In addition, as will also be described in more detail later in this disclosure, one or more processors of one or more server systems 112 of the multi-tenant system 102 may execute machine-executable instructions of the discount application module 404 to apply a discount charge application algorithm to one or more subscription charges to account for discount charges when determining various subscription metrics. Further, one or more processors of one or more server systems 112 of the multi-tenant system 102 may execute machine-executable instructions of the metrics visualization module 406 to generate one or more visualizations of subscription metrics, as will be described in more detail later in this disclosure as well.

Referring again to FIG. 2, in some embodiments, if subscription data that includes charge segment change log records has previously been migrated to the metrics service 208, there may be no need for the metrics service 208 to generate the query 212. Rather, the metrics service 208 may instead locally identify/retrieve the charge segment change log records 220 corresponding to the query parameters 206 in the API request 204, and may proceed to execute machine-executable instructions of the metrics calculation engine 210 to generate the desired subscription metric(s). It should be appreciated that the API request 204 may itself be a query regardless of whether the metrics service 208 generates the query 212 or not.

Upon calculating the subscription metric(s) corresponding to the metric parameter(s) specified among the query parameters 206, the metrics service 208 may return the calculated metric(s) 224 to the endpoint 202 in the API response 222. An example API response 222 is shown below. In this example representation of the API response 222, subscription metrics including gross MRR, net MRR, and TCV are returned for a subscription having a subscriptionNumber of “A-S00000001” within a subscription account having a subscriptionOwnerAccountNumber/invoiceOwnerAccountNumber of “A-00000001.” In addition, the example API response 222 below also includes data indicative of discounts applied to the subscription charge, in this case, a monthly recurring discount. Moreover, the example API response 22 below also includes a cursor key to enable paginating through multiple pages of the response 222.

```
{
  metrics: [
    {
      subscriptionOwnerAccountNumber: ″A-00000001″
      invoiceOwnerAccountNumber: ″A-00000001″,
      subscriptionNumber: ″A-S00000001″,
      chargeNumber: ″C-0000001″,
      segmentid: ″28828ab382bcd32328902″,
      startDate: ″2019-01-01″,
      endDate: ″2019-05-01″,
      mrr: {
        grossMrr: 20.0,
        discount: {
          discounts: [
            {
              discountChargeld: ″8929308988abc8e02323″
              discountMrr: 2.0
            }
            ],
            total: 2.0
          },
          netMrr: 18.0
        },
        tcv: { ... }
      }
    ],
    pageinfo: {
      pageSize: 10,
      hasNext: true,
      cursor: ″somecursorkey″
  }
}
```

In example embodiments, charge segment level subscription metrics can be aggregated to obtain higher-level metrics. For instance, a join query with a sum function can be utilized to obtain an higher-level metric (e.g., MRR for a subscription, MRR for an account, etc.) from a charge segment level metric (e.g., MRR for a particular charge segment). Moreover, a difference operation can be performed to obtain the delta MRR for a subscription amendment.

In some embodiments, API latency may be measured from the time the metrics service 208 receives the API request 204 to the time that the metrics service 208 sends the API response 222 to the endpoint 202. Thus, in some embodiments, the API latency may not be measured from an end-user's perspective (i.e., from the perspective of the endpoint 202) due to variability in network latency. In some embodiments, the expected API latency may be less than one second. In addition to API latency, in some embodiments, there may also be a replication latency associated with replicating subscription metrics from a back-end service (e.g., a billing service managed by the billing engine 216) to the metrics service 208. That is, in some embodiments, the subscription metrics may be generated at a back-end service that stores the charge segment change log records, and then replicated to storage in the metrics service 208. The latency between when a new version of a subscription is created (e.g., when a new charge segment change log record is created) and when corresponding subscription metrics are made available in the metrics service 208 may be the replication latency, which in some embodiments, may be less than one minute.

In some embodiments, the metrics service 208 may be configured to perform error handling to address errors in the API request 204, internal errors, or the like. For instance, if the API is implemented using a web-based protocol such as hypertext transfer protocol (HTTP), the metrics service 208 may return an HTTP code with the API response 222 that indicates that the response was successfully returned, or alternatively, that an error has occurred. For instance, an HTTP response code of “200” may indicate that the response 222 was successfully returned. Another non-error-related code may be HTTP code “301” indicating a redirect of the API request 204. For instance, if the metrics API is initially implemented in a service other than the metrics service 208 (e.g., a billing service provided by the billing engine 216), then the API in the billing service may return HTTP code 301 to redirect the API request 204 to the metrics service 208.

The API protocol that is employed may include a variety of HTTP response codes for various types of errors. For instance, HTTP response code “400” may indicate an invalid metric parameter specified in the API request 204. An invalid metric parameter may be one that does not identify an actual subscription metric capable of being calculated (e.g., metric=abc). As another non-limiting example, HTTP response error code “400” may indicate a missing required query parameter in the API request 204. For instance, the API request 204 may be required to specify at least one of the following query parameters: subscriptionOwnerAccountNumber, invoiceOwnerAccountNumber, or subscriptionNumber, and in the absence of at least one of these query parameters, the error code “400” may be returned. As still another non-limiting example, the HTTP response error code “400” may indicate that the API request 204 includes too many query parameters or query parameters that cannot be specified together in an API request. For instance, in some embodiments, querying by subscription or querying by account may be permitted in the alternative but not together. Other example HTTP error codes may include error code “405” indicating use of an HTTP method in the API request 204 other than the GET method and HTTP code “500” indicating an internal error. In some embodiments, the API response 222 may include empty metrics instead of the “404” error code if a non-existent subscription or account number parameter is specified in the API request 204.

In some embodiments, the minimum unit for a subscription metric calculation is a subscription. As such, from a pagination perspective, it may make sense to group metrics corresponding to the same subscription in the same page. However, it becomes challenging to do so because the number of subscription charges, and the number of subscription amendments reflected by the number of charge segments, can vary substantially from one subscription to another. For instance, a complex subscription may include potentially thousands of subscription charges and charge segments, whereas a simple subscription may include only a single subscription charge/charge segment.

Accordingly, in some embodiments, the metrics records included in the API response 222 may be flattened instead of grouped by subscription or account. Flattened metrics records may enable pagination to be handled more easily. In particular, if the metrics records are grouped by subscription and a particular subscription has a large number of charge segments, then paginating between different subscriptions within a given account may be difficult as it may require paginating through the numerous records of the particular subscription before reaching the records of the other subscription(s) in the account. In contrast, in order to return data evenly, pagination can be performed at the charge segment level to produce flattened metrics records.

In some embodiments, a cursor may be provided in the API response 222 to enable pagination through the metrics records at the charge segment level. In some embodiments, the cursor may be an encoded value of various query parameters. For instance, the cursor may be a base-64 encoded value of the following information: accountNumber, subscriptionNumber, segmentID, and startDate. The startDate may be included because even a single charge segment could be split into multiple sub-segments via application of a discount charge. Discount charge application will be described in more detail later in this disclosure.

As a non-limiting example, consider a query by subscription in which the API request 204 includes the subscription numbers A-S001 and A-S002. In this case, the initial query (i.e., the API request 204) may take the form: GET/charge-metrics?subscriptionNumbers=A-S001,A-S002&pageSize=100. In some embodiments, “charge-metrics?” may refer to a default set of one or more subscription metrics. The API response 222 that is returned for this query may contain subscription metrics for 100 segments, 90 of which may be associated with subscription A-S0001 and 10 of which may be associated with subscription A-S002. In addition, the API response 222 may include a cursor that can be used to generate the next query (i.e., the next API call) to paginate to the next page of subscription metrics. In particular, the next query make take the form of: GET/charge-metrics?subscriptionNumbers=A-S001,A-S002&pageSize=100&cursor=∥A-S002∥last-seg-id∥2019-02-01.

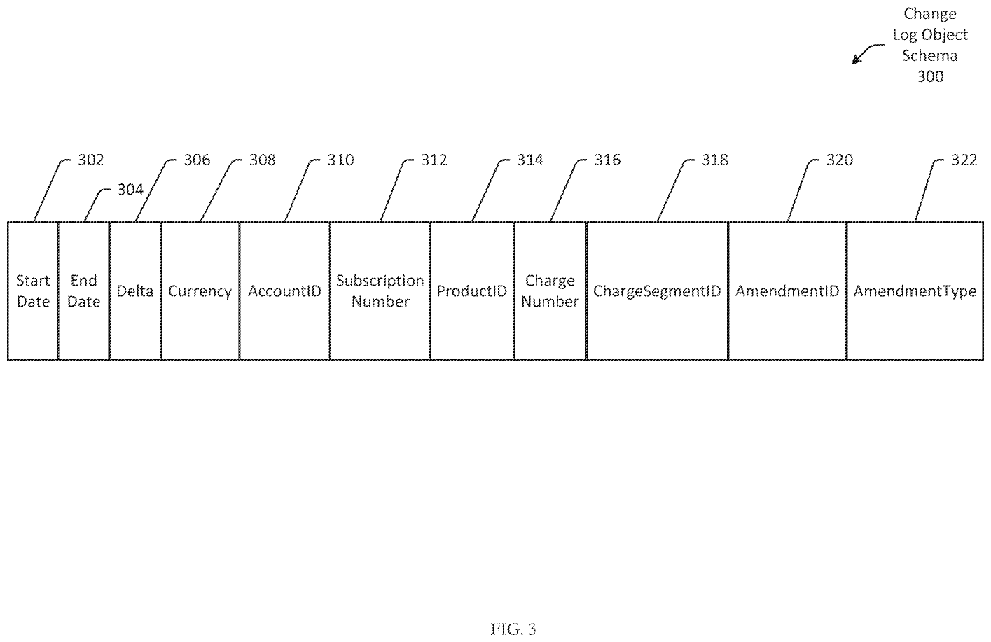

Referring now to FIG. 3, an example change log object schema 300 is depicted. In some embodiments, the charge segment change log records 220 depicted in FIG. 2 may adhere to the schema 300. That is, in some embodiments, the schema 300 may be defined at the charge segment level. The change log object schema 300 may include a start date data field 302 and an end date data field 304. Start and end dates respectively populated in fields 302 and 304 may specify a time period (referred to herein at times as a charge segment time segment) over which a subscription amendment to which the charge segment corresponds is applicable. For an evergreen subscription that does not have a predefined end date, a NULL value may be provided in the end date field 304. The schema 300 further includes a data field 306 for specifying a delta value representing an amount by which a corresponding subscription charge was increased or decreased as a result of the subscription amendment. The schema 300 additionally includes a currency data field 308, which may be populated with a currency code indicative of a currency in which the subscription charge is billed.

The schema 300 further includes various identifier data fields including an AccountID field 310 for specifying an account identifier (an account may include multiple subscriptions), a Subscription Number field 312 for specifying an identifier of a particular subscription of the account identified in field 310 (a subscription may include multiple subscription charges), a ProductID field 314 for specifying a particular product/service offered under the subscription, a Charge Number field 316 for specifying an identifier of a particular subscription charge of the subscription identified in field 312, and a ChargeSegmentID field 318 for specifying an identifier of a particular charge segment of the subscription charge identified in field 316.

The change log object schema 300 further includes an AmendmentID data field 320 and an AmendmentType data field 322. The AmendmentID field 320 may be populated with an identifier that uniquely identifies the particular subscription amendment that prompted creation of the change log record adhering to the schema 300. In some embodiments, the field 320 may be NULL in the change log record that is generated when a subscription/subscription charge is first created. The AmendmentType data field 322 may be populated with a change reason code, which may be selected from a set of predefined codes corresponding to different types of subscription changes or may be a custom-defined code. Examples of various types of predefined amendment types include, without limitation, an “add new product” amendment type (e.g., adding a new subscription product such as a new cellular line of service); an “update product” amendment type (e.g., changing to a new cellular plan); a “remove product” amendment type (e.g., removing a cellular line of service); a “term and condition” amendment type (e.g., changes to the term and/or conditions of an existing product offering); a “suspend” amendment type (e.g., suspending a particular subscription charge or subscription); a “resume” amendment type (e.g., resuming a suspended subscription charge or subscription); an “owner transfer” amendment type (e.g., transfer of a subscription from owner A to owner B); a “renewal” amendment type (e.g., renewal of an active subscription/subscription charge for a monthly/quarterly/annual renewal period); and so forth.

Change log records that adhere to the data model schema 300 which includes, among the other data fields, the delta value field 306 and the AmendmentType field 322 provide a linkage between the subscription metrics calculated by the metrics service 208 and the corresponding subscription amendments that yield those metrics. In some scenarios, an amendment type for a particular subscription charge may not, in and of itself, reveal the reason for the subscription change. For instance, an “add new product” amendment type may in fact be a down-sell that results in a subscription metric (e.g., MRR) decreasing if the added product is a discount charge. In some embodiments, the presence of the delta value field 306 and the AmendmentType field 322 together within the same change log object schema 300 allows an end-user, for example, to readily determine a change reason associated with a given amendment type. For instance, an end-user can determine whether an “Add New Product” code in the AmendmentType field 322 is associated with a revenue-increasing subscription change or a revenue-decreasing subscription change based on the delta value populated in the delta value field 306.

Moreover, the change log object schema 300 also permits an end-user to determine the individual change reasons for multiple subscription changes that may be temporally linked. For instance, assume that a subscription owner makes multiple changes to a subscription as part of a single subscription change event. In the absence of the data model provided by the change log object schema 300, it may not be possible to determine the change reason behind each subscription change and the respective impact that each change had on one or more subscription metrics. For instance, if a subscription owner removes two products, adds one new product, and changes the time period over which another product's subscription charge is applicable—all as part of a single subscription change event—it would be difficult to ascertain the individual subscription metric impact of each such change. The change log object schema 300, however, does, in fact, enable this level of granularity because a charge segment change log record is generated for each such individual subscription change, thereby allowing an end-user to determine, based on each change log record that is generated, the linkage between the change reason code populated in the AmendmentType field 322 of the change log record and the delta value populated in field 306 of the change log record.

FIG. 5A illustrates example charge segment change logs and metrics segments in accordance with example embodiments of the disclosed technology. The change log records 502 depicted in FIG. 5A may adhere to the change log object schema 300. That is, while depicted as condensed representations with various data fields of the schema 300 excluded for ease of explanation, the actual stored change logs 502 may also include values for the additional fields of the schema 300 that are not depicted in FIG. 5A. The change log records 502 may be stored in a ChangeLog table or any other suitable data structure. In some embodiments, change log records associated with subscriptions from different subscription accounts may be stored in the same data structure or in different data structures. The stored change log records 502 may be ordered—with each new charge segment change log record that is generated responsive to a corresponding subscription amendment being appended to an existing set of one or more charge segment change log records. It should be appreciated, however, that there may not be an existing set of change log record(s) in the case of an initial charge segment change log record that is generated responsive to the initial creation of a subscription/subscription charge. It should further be appreciated that the terms “charge segment change log record,” “change log record,” or variations thereof may be used interchangeably herein.

Referring now in more detail to the example depicted in FIG. 5A, when a subscription is first created with a subscription charge (i.e., Charge1), or a new product with a corresponding subscription charge is added to an existing active subscription, a corresponding charge segment change log record may be created (i.e., Charge1-Segment1) and stored. This subscription change may correspond to an “Add New Product” amendment type, for example. This initial charge segment change log record may include a delta value of +5, indicating that the initial subscription charge is $5 per month, and may include start and end dates of January 1 and April 1, respectively, which together indicate the time segment over which the subscription charge is applicable. In some embodiments, the end date may be a date on which the subscription needs to be renewed (either automatically or in response to specific user input) in order for the subscription to remain active. In those embodiments in which a subscription includes multiple subscription charges, the different subscription charges may be associated with different end dates corresponding to different renewal periods.

In some embodiments, a subscription may be an evergreen subscription that does not specify an end date for one or more subscription charges. For example, the charge segments corresponding to a subscription charge for an evergreen subscription may have a NULL value in the end date field—indicating that periodic billing of the subscription charge will continue until actively canceled. A charge segment change log record having an end date that is NULL effectively represents a charge segment of infinite length. As such, for an evergreen subscription, it may not be possible to calculate (or may otherwise be unreasonable to calculate) subscription metrics that are measured across some finite period of time. For instance, the subscription metric TCV may only make sense for charge segments having a finite term. Thus, finite-term subscription metrics TCV may not be calculated/returned by evergreen subscriptions. On the other hand, subscription metrics that do not require an overall finite subscription term, such as MRR, which can be calculated on a month-by-month basis, may be a valid metric to return for both termed and evergreen subscriptions.

In some embodiments, a default periodicity of the subscription charge may be selected for the collection of change log records 502. For instance, the default periodicity may be monthly, quarterly, or annually. In some embodiments, the default periodicity of the delta values of the change log records 502 may be the same as or different from the actually billing periodicity of the subscription charge. For instance, while the subscription charge may be billed annually, the delta values for the change log records corresponding to the subscription charge may be monthly charge amounts. Alternatively, in some embodiments, the change log object schema 300 may include an additional field that may be populated with a code that indicates the periodicity of the delta value field.

Assume now that a subscription amendment is made on February 1 that results in the subscription charge “Charge1” increasing by $5 per month. The amendment may be, for example, a modification of an existing product offering under the subscription (e.g., an increase in allocated cloud digital video recording (DVR) capacity), which may correspond to the “Update Product” amendment type. As a result, a new charge segment change log record (i.e., Charge1-Segment2) may be generated and appended to the initial change log record for Charge1-Segment1. This new charge segment change log record may specify a start date corresponding to the date that the subscription amendment is effective (February 1) and an end date of April 1 (e.g., the date the subscription and/or the product corresponding to the subscription charge “Charge1” is inactivated if not renewed). In addition, this change log record includes a delta value of +5. Assume still further that another subscription amendment is made on March 1 that results in the subscription charge “Charge1” increasing again by $5 per month. A corresponding charge segment change log record is generated with start and end dates of March 1 and April 1, respectively, and a delta value of +5.

The change logs 502 also include a charge segment change log record corresponding to a different subscription charge (i.e., “Charge2”) within the same subscription. In particular, as previously noted, a single subscription may include multiple subscription charges corresponding to different product/service offerings available within the same subscription. In this example, when the new subscription charge “Charge2” is created with a monthly recurring charge amount of $3, the corresponding charge segment change log record (i.e., “Charge2-Segment1”) is generated. This change log record may include start and end dates of January 1 and April 1, respectively, corresponding to the time segment over which the charge is applicable as well as a delta value of +3 representing the monthly recurring charge amount. In some embodiments, charge segment change log records corresponding to the same subscription charge within a given subscription may be grouped together, as shown in FIG. 5A. Alternatively, all charge segment change log records corresponding to a given subscription may be ordered based on their respective start dates (i.e., the dates of the corresponding subscription changes) regardless of the particular subscription charge to which they relate. In still other embodiments, the change log records corresponding to one or more subscription charges may not be stored in any particular order. In such embodiments, the change log records may be ordered based on start date (and potentially grouped according to subscription charge) prior to calculating subscription metrics from the change log records.

In addition to creation of a new subscription/subscription charge (e.g., an “Add New Product” amendment) or modification of an existing subscription charge (e.g., an “Update Product” amendment), other types of subscription amendments may also trigger creation of corresponding charge segment change log records. For example, another type of subscription amendment may be the shrinking of a time segment over which a subscription charge is applicable. For instance, assume that the following charge segment change log record exists: [2019-01-01, 2020-01-01, +15], representing a recurring subscription charge of $15 per month applicable from Jan. 1, 2019 to Jan. 1, 2020. Further assume that the subscription is amended to change the end date from Jan. 1, 2020 to Oct. 1, 2019, essentially shrinking the segment by three months. The following charge segment change log record may be generated for this subscription amendment: [2019-10-01, 2020-01-01, −15]. Because the original change log record extends from Jan. 1, 2019 to Jan. 1, 2020 with a delta value of +15, the creation of the change log record [2019-10-01, 2020-01-01, −15] effectively negates the subscription charge (+15+(−15)=0) for the months of October 2019, November 2019, and December 2019, resulting in an MRR of 0 for these months. For instance, the MRR on Nov. 1, 2019 may be calculated based on the following example query: select sum(change) from metrics_log where start_date>=‘2019-11-01’ AND end_date<=‘2019-11-01’.

Another type of subscription amendment that may occur is the extension of a time segment over which a subscription charge is applicable. Referring again to the example introduced above, assume that the subscription is extended from the end_date of Oct. 1, 2019 to a new end_date of Feb. 1, 2020. In this scenario, the following corresponding change log record may be generated: [2019-10-01, 2020-02-01, +15]. At this point, the following charge segment change log records would exist for this subscription charge: [2019-01-01, 2020-01-01, +15]; [2019-10-01, 2020-01-01, −15]; [2019-10-01, 2020-02-01, +15]. A subscription metric such as MRR on a certain date could then be calculated by summing the respective delta values for each charge segment change log record that includes a charge segment time segment that encompasses that date. For example, MRR on any date that falls between Oct. 1, 2019 and Feb. 1, 2020 would be calculated by summing the respective delta values of all three change log records: +15+(−15)+15=+15. Both the shrinking of a charge segment and the extension of a charge segment may be a term and condition (“T&C”) type of amendment.

Still further types of amendments that can be made to a subscription include a “Suspend Amendment,” corresponding to suspension of a subscription/subscription charge for a period of time, and a “Resume Amendment,” corresponding to resumption of a suspended subscription/subscription charge. Referring again to the example from above, assume that the subscription is suspended on Nov. 1, 2019. Then, the following charge segment change log record would be generated: [2019-11-01, 2020-02-01, −15]. Further assume that the subscription is again resumed on Dec. 1, 2019. Then, the following charge segment change log record would be generated: [2019-12-01, 2020-02-01, +15]. At this point, the following collection of charge segment change log records would exist for this particular subscription charge: [2019-01-01, 2020-01-01, +15]; [2019-10-01, 2020-01-01, −15]; [2019-10-01, 2020-02-01, +15]; [2019-11-01, 2020-02-01, −15]; [2019-12-01, 2020-02-01, +15]. In some embodiments, the charge segment change log records may be immutable. That is, the ChangeLog table or other type of data structure used to store the change log records may be an append-only data structure in which new records can only be added and existing records cannot be deleted. In this manner, retention of the historical details of a subscription including all amendments made to the subscription over time is ensured.

In some embodiments, an “Owner Transfer” amendment is another example type of subscription amendment that can be made. In some existing methodologies, when a subscription is transferred from account A to account B, all historical details of the subscription are also transferred to account B. In particular, the owner account references are changed from account A to account B, resulting in a transfer of the subscription history from account A to account B, and causing the original account owner (account A) to lose access to all subscription details, including those details corresponding to a time period during which the subscription was still under the ownership of account A. In contrast, the “Owner Transfer” subscription amendment according to embodiments of the disclosed technology enables subscription details to be transferred from account A to account B without account A losing access to subscription information for the time period during which the subscription was under the ownership of account A.

For example, assume that the following charge segment change log record exists for a particular subscription initially owned by account A: [2020-01-01, 2021-01-01, +15]. Assume further that the subscription is transferred to account B on Jun. 1, 2020. As a result, several additional charge segment change log records may be generated. In particular, a new charge segment change log record may be generated in account B that is the same as the existing one in account A, i.e., [2020-01-01, 2021-01-01, +15]. In addition, another charge segment change log record may be generated for account B, specifically, [2020-01-01, 2021-06-01, −15]. In this manner, the combination of the change log records [2020-01-01, 2021-01-01, +15] and [2020-01-01, 2021-06-01, −15] in account B ensures that historical details of the subscription are transferred over to account B, while at the same time, indicating that the subscription was not under the ownership of account B from Jan. 1, 2010 to Jun. 1, 2020. With respect to account A, the existing change log record [2020-01-01, 2021-01-01, +15] may be retained in account A—thereby ensuring that account A continues to have access to historical subscription details relating to the time period during which the subscription was under the ownership of account A. Moreover, an additional charge segment change log record, i.e., [2020-06-01, 2021-01-01, −15], may be generated for account A to indicate that the subscription ownership was changed on Jun. 1, 2020.

FIG. 5A also depicts various metrics segments 504 that can be generated from the change log records 502. More specifically, in some embodiments, computer-executable instructions of the metrics segment generation module 402 (FIG. 4) may be executed to convert the change log records 502 into the metrics segments 504 as part of the calculation of subscription metrics performed by the metrics calculation engine 400. In some embodiments, each metrics segment 504 may correspond to a predetermined time segment such as a month, a quarter, etc. The metrics segments 504 depicted in FIG. 5A span a month time period, for example. The subscription metric illustratively depicted as being calculated for the metrics segments 504 is MRR. It should be appreciated, however, that metrics segments may be generated for other subscription metrics as well such as net ARR, MCV, TCV, or the like.

In example embodiments, the metrics segment generation module 402 may generate metrics segments corresponding to a given subscription charge based only on those charge segment change log records that correspond to that subscription charge. For instance, the first three metrics segments depicted in FIG. 5A, i.e., “Metrics Segments 1-3,” may be generated based on the charge segments corresponding to subscription charge “Charge 1,” whereas the fourth metrics segment, i.e., “Metrics Segment 4,” may be generated based on the charge segment corresponding to subscription charge “Charge 2.”

Referring now to an example algorithm for generating the metrics segments 504, when generating a metrics segment for a particular time segment, the metrics segments generation module 402 may first identify each charge segment change log record associated with a time segment that encompasses the particular time segment for which the metrics segment is being generated. Upon identifying each such charge segment, the module 402 may then sum the respective delta values of the identified charge segments to obtain the subscription metric value for the metrics segment corresponding to that particular time segment. For instance, when generating “Metrics Segment 1,” the module 402 may first identify each charge segment change log record with a time segment that encompasses the time period from January 1 to February 1. In this example, the charge segment from January 1 to April 1 is the only charge segment that encompasses this time period. Accordingly, the delta value of “Charge1-Segment1” (+5) is the only value to include for the MRR subscription metric in “Metrics Segment 1.”

When generating the metrics segment “Metrics Segment 2” for the time period from February 1 to March 1, however, the module 402 identifies two charge segment change log records with corresponding time segments that encompass this period. In particular, both the charge segment “Charge1-Segment1” and the charge segment “Charge1-Segment2” correspond to respective time segments, i.e., January 1 to April 1 and February 1 to April 1, that encompass the time period from February 1 to March 1. Accordingly, the module 402 may sum the respective delta values of “Charge1-Segment1” and “Charge1-Segment2” (i.e., +5+(+5)=+10) to obtain the value of the MRR subscription metric for “Metrics Segment 2.” The module 402 may apply similar logic to obtain the value of the MRR subscription metric for “Metrics Segment 3,” i.e., +15. When generating “Metrics Segment 4,” on the other hand, the module 402 may consider only those charge segment change log records associated with subscription charge “Charge2,” which in this example, is only “Charge2-Segment1.” As such, the value of the MRR subscription metric for “Metrics Segment 4” is the delta value of +3 in the charge segment “Charge2-Segment1.”

FIG. 5B depicts an example collection of charge segment change logs 506. In some embodiments, different types of visualizations can be produced from the change log records 506. More specifically, machine-executable instructions of the metrics visualization module 406 (FIG. 4) may be executed to produce, for example, a subscription visualization 508 of the change logs 506 or an order/booking visualization 510 of the change logs 506. In some embodiments, the metrics segment generation module 402 may first convert the charge segment change log records 506 into corresponding metrics segments as described in reference to FIG. 5A, and the metrics visualization module 406 may receive the converted metrics segments as input and generate the corresponding subscription visualization 508. As shown, the subscription visualization 508 may provide a graphical representation of a calculated subscription metric from the metrics segments (e.g., MRR). In contrast, in some embodiments, the metrics visualization module 406 may generate the order/booking visualization 510 directly from the change log records 506 without a need for the intermediate generation of metrics segments. The order/booking visualization 510 may provide a graphical depiction of the corresponding delta value and time segment over which the delta value is applicable for each charge segment change log record 506.

Example pseudo-code of an algorithm for generating metrics segments corresponding to the change log records 506, which can then serve as the basis for the subscription visualization 508, is shown below.

```
  1. Get all dates => (2019-01-01, 2019-02-01, 2019-03-01, 2019-04-01)
  2. Generate the period list => [01-01, 02-01), [02-01, 03-01), [03-01,
04-01) as periodList
  3. periodList.map(period => {
    total = segments.filter(containsPeriod).sum(delta));
    segment = new Segment(period, total);
    segment.id = segments.find(seg => seg.startDate = period.
    startDate).id; return segment;
  });
```

In some embodiments, it may not be possible to convert directly from the subscription visualization 508 to the order/booking visualization 510 because in doing so some information loss may occur such as the presence of any shrinking charge segments. Accordingly, in some embodiments, in order to obtain an accurate order/booking visualization 510, snapshots of two versions of the subscription may be compared. Example pseudo-code of an algorithm for performing such a comparison is shown below.

Given subscription Sv1 and Sv2, get their charge segments as segList1 and segList2;

Group segList1 and segList2 by chargeNumber, so you have chargeSegments1,chargeSegments2 in format of <chargeNumber, List<segment>>

If chargeSegments2 has more charges than chargeSegments1, new charge was added. Generate the changeLog for the new-added charge first, then remove the charge from the chargeSegments2 map.

```
  For each charge in chargeSegments2
    segments2 = get segments by chargeNumber from chargeSegments2
    segments 1 = get segments by chargeNumber from chargeSegments1
  segments2 zip segments 1 by segment number to get segmentPairs in
format of [segmentlV2, segmentlV1], [segment2V2, segment2V1],
[segment3V2, segmentsV1],...
  changeLogs = segmentPairs.map(diff).filter(notNull)
  end
```

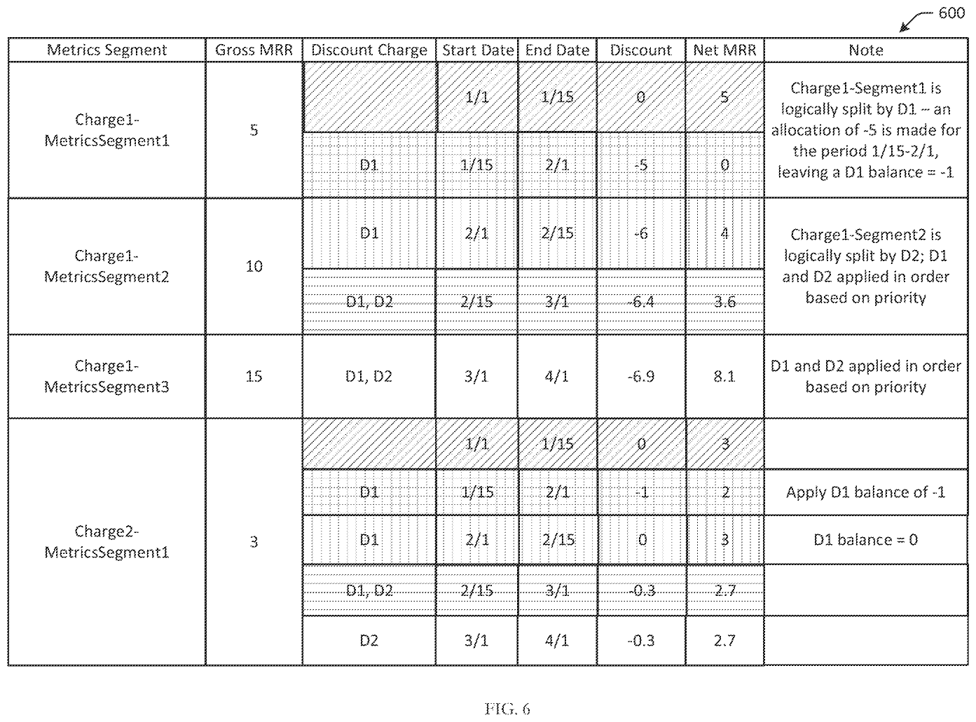

FIG. 6 illustrates the application of a fixed discount and a percentage discount to a collection of subscription charges based on a predetermined discount class priority in accordance with embodiments of the disclosed technology. In the example of FIG. 6, a subscription includes two subscription charges—“Charge1” and “Charge2.” There are three charge segment change log records associated Charge1 and one charge segment change log record associated with Charge2. In addition, a fixed discount D1 and a percentage discount D2 are initiated for the subscription charges on January 15 and February 15, respectively. Discounts D1 and D2 may be subscription-level discounts that are applied to both subscription charges (Charge1 and Charge2) in the subscription. In addition, discounts D1 and D2 are recurring monthly discounts in this example, with discount D1 having a value of −6 per month and discount D2 being a 10% monthly discount. The value of discount D1 (i.e., −6) is assumed to be a total cumulative discount balance available across all subscription charges (i.e., Charge1 and Charge2). Further, in this example, fixed discounts are in a discount class that is assigned a higher predetermined priority than the discount class that includes percentage discounts, which means that discount D1 is applied before discount D2 is applied. It should be appreciated that other discount class priorities may be assigned in other embodiment. It should further be appreciated that the shading in FIG. 6 is utilized to indicate corresponding time segments/sub-time segments between Charge1 and Charge2.

The example of FIG. 6 is based on the following illustrative set of charge segment change log records: Charge1-Segment1: [1/1, 4/1, +5]; Charge1-Segment2: [2/1, 4/1, +5]; Charge1-Segment3: [3/1, 4/1, +5]; and Charge2-Segment1: [1/1, 4/1, +3]. In some embodiments, the metrics segment generation module 402 may generate the following metrics segments from the above set of change log records: Charge1-MetricsSegment1: [1/1, 2/1, MRR=5]; Charge1-MetricsSegment2: [2/1, 3/1, MRR=10]; Charge1-MetricsSegment3: [3/1, 4/1, +15]; and Charge2-MetricsSegment4: [1/1, 4/1, MRR=3]. The table 600 depicted in FIG. 6 illustrates how discounts D1 and D2 can be applied to the above metrics segments.

Because discount D1 is initiated mid-month on January 15, the metrics segment “Charge1-MetricsSegment1” is logically split by discount D1. In particular, an allocation of −5 from is made from the discount D1 balance for the sub-time segment from January 15 to February 1 for Charge1-MetricsSegment1 to completely offset the gross MRR of +5 for this metrics segment, resulting in a net MRR of +5 for the time period from January 1 to January 15 and a net MRR of 0 for the time period from January 15 to February 1 for Charge1-MetricsSegment1. This leaves a discount balance of −1 for discount D1, which is applied to the metrics segment for the other subscription charge Charge2 (i.e., Charge2-MetricsSegment1) for the sub-time segment from January 15 to February 1, resulting in a net MRR of +3 for the sub-time segment from January 1 to January 15 and a net MRR of +2 for the sub-time segment from January 15 to February 1.

Referring now to the second metrics segment for Charge1 (i.e., “Charge1-MetricsSegment2”), the gross MRR for this metrics segment is +10. Further, because discount D2 is initiated on February 15, this metrics segment is logically split by discount D2. The full discount balance of −6 of discount D1 is applied to this metrics segment for subscription charge Charge1, leaving no available balance for the subscription charge Charge2. This results in a net MRR of +4 for the sub-time segment from February 1 to February 15 for Charge1-MetricsSegment2 and a net MRR of +3 for the sub-time segment from February 1 to February 15 for Charge2-MetricsSegment2.

For the sub-time segment from February 15 to March 1, both discounts D1 and D2 are applied to each subscription charge (Charge1 and Charge2). Thus, for metrics segment Charge1-MetricsSegment2, application of discount D1 to the sub-time segment from February 15 to March 1 results in an exhaustion of the entire discount balance of −6, bringing the intermediate net MRR to 4. Then, discount D2 (i.e., a 10% discount in this example) is applied to the intermediate net MRR of 4, resulting in an additional discount of −0.4=4*−10%, and bringing the total discount amount to −6.4 for the sub-time segment from February 15 to March 1. As such, the net MRR for the sub-time segment from February 15 to March 1 for Charge1-MetricsSegment2, which is given by gross MRR−total discount amount, is 10−6.4=3.6. For the corresponding sub-time segment from February 15 to March 1 for the metrics segment “Charge2-MetricsSegment1” corresponding to subscription charge Charge2, the balance of discount D1 has been exhausted after application to subscription charge Charge1, and as such, the percentage discount D2 is the only discount applied. Since gross MRR is +3 for this time segment, the discount amount becomes −0.3, which is −10% of the gross MRR. As such, the net MRR for the sub-time segment from February 15 to March 1 for Charge2-MetricsSegment1, which is given by gross MRR−total discount amount, is 3−0.3=2.7.

Finally, with respect to the time segment from March 1 to April 1, this time segment is not logically split by either discount D1 or discount D2 because each discount is already in place prior to March 1. Accordingly, for the metrics segment “Charge1-MetricsSegment3” for subscription charge Charge1, discount D1 is first applied to the gross MRR, followed by application of discount D2. In particular, application of discount D1 exhausts the entire discount balance of −6, resulting in an intermediate MRR of 15−6=9 (gross MRR−discount D1 balance). The percentage discount D2 is then applied to this intermediate MRR to obtain an additional discount of −0.9=9*−10%. This gives a total discount amount of −6.9=−6+(−0.9). Thus, the net MRR for the time segment from March 1 to April 1 for metrics segment Charge1-MetricsSegment3, which again is given by gross MRR−total discount amount, is 15−6.9=8.1. For the metrics segment Charge2-MetricsSegment1 associated with subscription charge Charge2, on the other hand, the entire balance of discount D1 has been exhausted via application to Charge1, and thus, is discount D1 is unavailable for Charge2 for this time segment. Accordingly, only percentage discount D2 is applied, resulting in a discount amount of −0.3=Gross MRR*−D2=3*−10%. Thus, the net MRR for this time segment for subscription charge Charge2 is 3−0.3=2.7.

The above example demonstrates how a discount charge application for a given subscription charge in a subscription can be impacted by other subscription charges within the same subscription. For example, the amount of discount A applied to subscription charge Charge2 is impacted by the amount of subscription charge Charge1 and the corresponding allotment of discount A to Charge1. Further, in some embodiments, a discount charge may be an account-level discount that is applied to multiple subscriptions within a given account. Such a discount charge may be referred to as an account-level discount charge. Consider, for example, an account that includes three subscriptions: S1, S2, and S3. If, for example, an account-level discount charge is applied to one of the subscriptions (e.g., S2), then calculating a subscription metric (e.g., net MRR) for any given subscription (e.g., S3) may require knowing the discount application that is applied to the other subscriptions.

In some embodiments, an algorithm for applying discount charges to a subscription utilizing the methodology detailed in the example of FIG. 6 can be implemented using the following example pseudo-code. For instance, the discount application module 404 may include machine-executable instructions for executing a discount application algorithm based on the following pseudo-code. The pseudo-code provided below as well as other pseudo-code provided herein may include non-executable comments that begin with ‘//’ and which provide context for the various pseudo-code statements.

```
  chargeSegments
    // if a discount applies to multiple charges, sort the charge by
    chargeNumber
    .sortBy(seg => seg.chargeNumber)
    //list all regular charges
    .filter(seg => seg.charge is not discount)
    // apply discount to each regular charge, a regular segment could be
logically split by discounts
    .flatMap(seg => {
      applicableDiscounts = discountApplicationList
        filter(tuple => tuple.2.contains(seg.charge) || tujple.1 is
accountLevelDiscount)
        .map(tuple => tuple.discount)
      //List of ‘[StartDate, EndDate], GrossMRR, applicableDiscounts’,
      subSegs = splitSegByDiscounts(seg, applicableDiscounts);
      subSegs.map(subSeg => {
        netMRR= subSeg.applicableDiscounts.fold(GrossMRR, (acc,
discount) => {
          if discount is pct {
            acc = acc − acc * discount.pct;
          } else {
            // fixed amount discount is stateful, need to keep track
of the to-be-applied balance
            acc = acc − getDiscountBalance(discount, subSeg.period);
          }
        });
        return (sub Seg.period, GrossMRR, discountAmount, NetMRR)
      });
    });
    .groupBy(seg => seg.period) // (period, List<seg>)
    .map(entry => (period, entry,value( ).sum( ))); // sum all subSeg
within the same period
```

Referring again to FIG. 2, in some embodiments, when calculating the subscription metrics 224, the metrics calculation engine 210 may include, or otherwise execute, computer-executable instructions that implement the pseudo-code below. One or more processors of one or more server systems 110 of the multi-tenant system 102 may execute such computer-executable instructions to cause any applicable discount charges to be applied as part of the calculation of the subscription metrics 224.

```
  1. Get charge segment stream (segmentstream) by subscriptionNumber
(s) and accountNumber(s), sort by chargeNumber
  2. Get applicable discount charges(discounts)
  3. metrics = segmentstream.flatMap(segment -> applyDiscount
(discounts, segment);
  4. Construct the response body.
```

Further, in order to retrieve the applicable discount charges, the metrics calculation engine 210 may include, or otherwise execute, computer-executable instructions that implement the pseudo-code below. One or more processors of one or more server systems 110 of the multi-tenant system 102 may execute such computer-executable instructions to retrieve any applicable discount charges so that they can then be applied as part of the calculation of the subscription metrics 224.

```
  chargeSegments = list Segments by SubscriptionName and Status
  // To get a list of (Discountcharge, List<AppliedRpc>)
  discountChargelDs = chargeSegments
    .filter(seg => seg. charge.chargeModel is Discount && applyLevel
    is not ‘account’)
    .map(seg => seg.charge.originalRpcId);
  discountApplicationList = query by discountChargelds then group
  by discount
  // append account level discount(s)
  charge Segments
    .filter(seg => seg.charge is account level discount)
    .map(seg => seg.charge)
    .forEach(charge => discountApplicationList.append( (charge,
    empty( ))))
  // check if there are other subscriptions of this account that have an
account-level discount charge
  accountLevelDiscountsInOtherSubscriptions = dbQuery then transform
  accountLevelDiscountsInOtherSubscriptions
    .forEach(charge => discountApplicationList.append( (charge, empty
    ( )))
  // sort the list by discount sorting logic
  discountApplicationList. sortBy(charge);
```

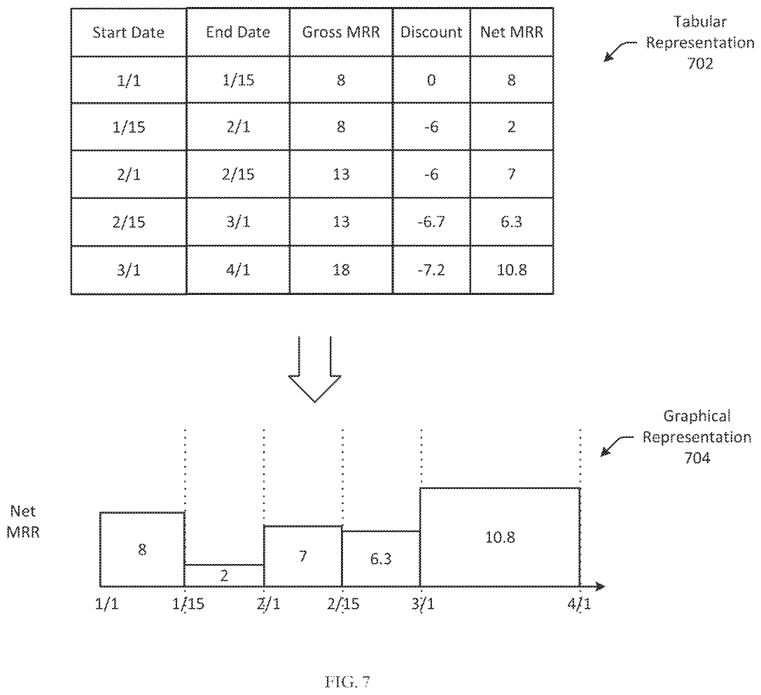

FIG. 7 illustrates tabular and graphical representations of subscription metrics in accordance with embodiments of the disclosed technology. FIG. 7 depicts a tabular representation 702 of the various subscription metrics (e.g., gross MRR, net MRR, etc.) associated with the metrics segments from the example depicted in FIG. 6. In particular, each row of the tabular representation 702 corresponds to a sub-time segment or time segment from the example of FIG. 6, and the gross MRR, net MRR, and discount specified in each row is the sum of the gross MRR, net MRR, and total discount applied for both subscription charges Charge1 and Charge2. Thus, for example, for the sub-time segment from January 15 to February 1, the gross MRR is the sum of the gross MRR for Charge1 for that sub-time segment (i.e., +5) and the gross MRR for Charge2 for that sub-time segment (i.e., +3); the discount is the sum of the discount for Charge1 for that sub-time segment (i.e., −5) and the discount for Charge2 for that sub-time segment (i.e., −1); and the net MRR is the sum of the gross MRR sum (i.e., +8) and the discount sum (i.e., −6).

In some embodiments, computer-executable instructions of the metrics visualization module 406 may be executed to transform the tabular representation 702 into a graphical representation 704. The graphical representation 704 may include a timeline with designators delineating the various time segments for which a subscription metric has been calculated (e.g., net MRR) as well as a representation of the calculated subscription metric for each time segment. While net MRR is illustrated as an example subscription metric, it should be appreciated that other subscription metrics (e.g., gross MRR, ARR, TCV, etc.) and/or discount amounts may be visualization in the graphical representation 704. In some embodiments, multiple different metrics may be visualized simultaneously in the representation 704 to facilitate comparison of the metrics. In addition, while a histogram-type visualization is depicted in FIG. 7, it should be appreciated that other types of visualizations are also within the scope of this disclosure.

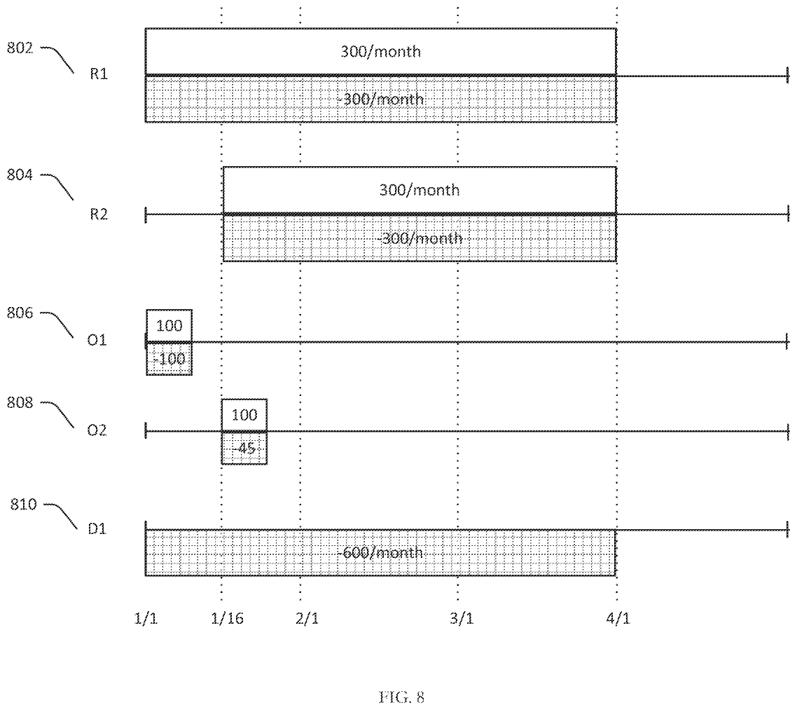

FIG. 8 graphically illustrates application of a fixed amount recurring discount to a combination of recurring and one-time subscription charges in accordance with embodiments of the disclosed technology. Because recurring metrics such as MRR are not meaningful for one-time subscription charges, application of a fixed amount discount to a one-time subscription charge differs from application of a fixed discount to a recurring subscription charge in some embodiments. In the example of FIG. 8, there are two recurring subscription charges R1 and R2, each in the amount of $300 per month, and two one-time charges O1 and O2, each in the amount of $100. Further, a fixed amount recurring discount charge D1 is $600 per month, which is graphically represented in FIG. 8 as element 810.

According to the discount application logic in example embodiments, the discount charge D1 is applied to recurring subscription charges prior to being applied to one-time subscription charges. Because the discount charge D1 and the recurring subscription charges R1 and R2 have the same units, i.e., $X per month, the discount MRR can be subtracted directly from the recurring charge MRR. Thus, for the time segment from January 1 to February 1 (i.e., the month of January), a discount MRR of $300 per month is subtracted from the MRR of recurring subscription charge R1 to yield a discount charge balance of ($600/month−$300/month)*1 month=$300. A graphical representation 802 of the application of the discount charge MRR to the MRR of recurring subscription charge R1 is shown in FIG. 8. Then, the remaining balance of the discount MRR (i.e., $300/month) may be applied to recurring subscription charge R2, but only for a partial segment of the time segment from January 1 to February 1 since the start date for charge R2 is January 16. Thus, the total discount MRR applied to R2 for January is given by $300/month*(16/31)*1 month=$155. This leaves a discount MRR balance of $300−$155=$145. Application of the discount MRR to recurring subscription charge R2 is illustrated in graphical representation 804.

With respect to the one-time charge O1, which is $100, a commensurate portion of the discount charge D1 balance of $145 for January can be applied to O1, resulting in a net TCV for the one-time charge O1 of $0 and a remaining discount charge balance of $45. This is illustrated by graphical representation 806. With respect to one-time charge O2, which is also $100, only $45 of the discount charge D1 remains in January for application to one-time charge O2. Upon application of the remaining January balance of the discount charge D1 to one-time charge O2, the TCV for one-time charge O2 becomes $100−$45=$55 and discount charge D1 for January is exhausted. This is illustrated by graphical representation 808.

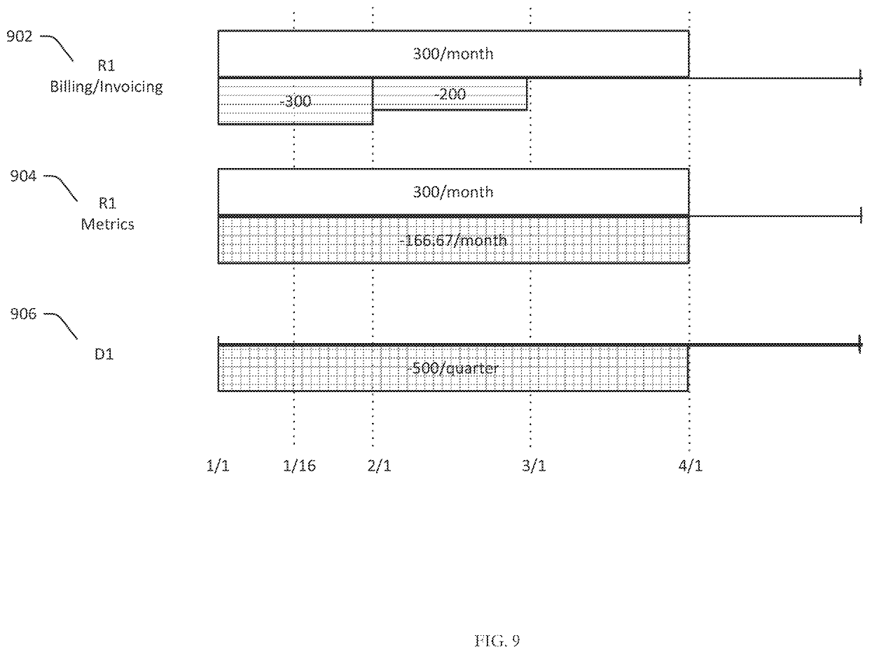

FIG. 9 graphically illustrates alternate representations of application of a recurring discount. For example, in the invoicing context, the fixed amount discount may be handled differently than when calculating subscription metrics according to embodiments of the disclosed technology. This may be the case because invoicing has a different associated intention—to collect payment. As such, an eager allocation model may be adopted for applying a fixed amount discount in the invoicing context.

A graphical representation 906 of an example fixed amount discount D1 of −$500 per quarter is shown in FIG. 9. In the invoicing/billing context, $300 of the quarterly fixed amount discount D1 may be applied to the first month, $200 to the second month, and $0 to the third month. A graphical representation 902 of this discount application methodology is shown in FIG. 9. In contrast, in the subscription metric generation context, the quarterly discount D1 may be divided equally among the three months, as shown in graphical representation 904.

In some embodiments, subscription/booking metrics and billing metrics may address different concerns. In particular, in some embodiments, bookings represent the commitment of a customer to engage in a certain level of spending with a service provider. This commitment may be formalized in the form of a contract at the time that the customer signs up for a subscription. Subscription/booking metrics may be used, for example, for revenue prediction, contract value measuring, or the like. In contrast, in some embodiments, billing refers to actual collections from customers. That can occur at the time of booking if the customer is providing payment in advance, or alternatively, at the time of revenue recognition in the scenario in which the customer is paying monthly, even if the subscription includes a long period of commitment (e.g., one year).

As a result of their differing treatment, calculation of subscription/booking metrics and billing metrics may differ with respect to certain subscription parameters such as discount charge application. In particular, the calculation of these different metric types may involve different settings/configuration rules at different phases in the calculation process. As a non-limiting example, these different metric types may differ with respect to their supported charge types. For instance, certain subscription/booking metrics such as MRR, TCV, or the like may support only recurring charges, whereas billing metrics may support recurring and non-recurring charges. As another non-limiting example, these different metric types may differ in their billing periods. For instance, subscription/booking metrics may align the billing period with the calendar month, whereas billing metrics may utilize a Billing Cycle Day (BCD). As yet another non-limiting example, these different metric types may employ different discount application rules. For instance, in some embodiments, subscription/booking metrics may only support one-time or recurring charges but not usage-based charges. However, because discount charges may be applicable to any type of charge, there may be a different in discount application in the billing context if a fixed amount discount charge is applied to a usage-type charge first and then to a recurring charge.

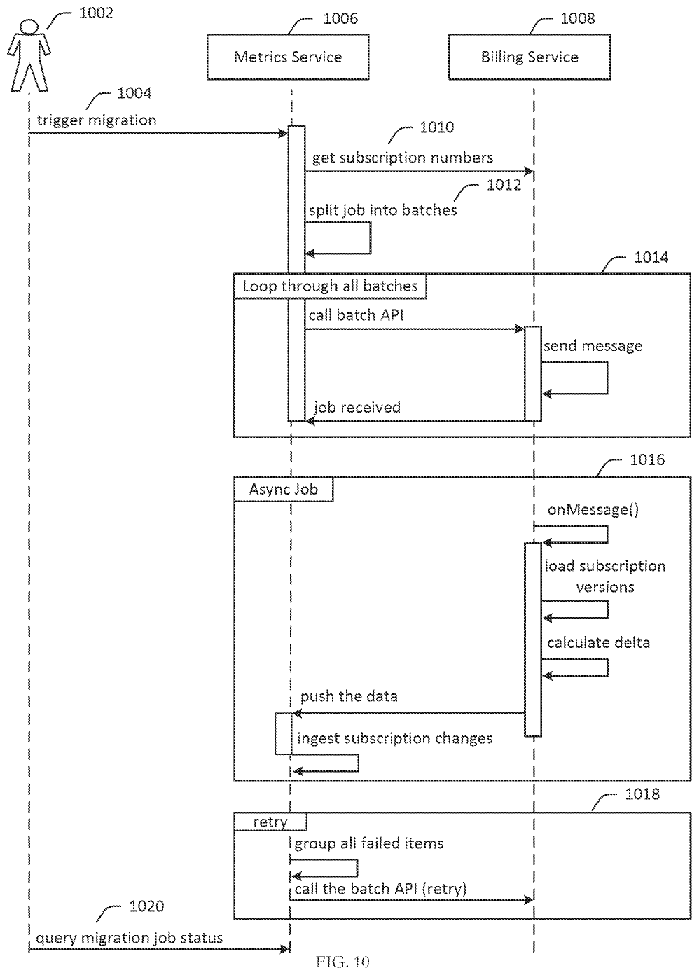

FIG. 10 illustrates a process flow for migration of charge segment change logs from a billing service to a metrics service in accordance with embodiments of the disclosed technology. In some embodiments, the metrics service 1006 may be a particular implementation of the metrics service 208 and the billing service may be particular implementation of a service implemented by the billing engine 216. As previously described, the metrics service 1006 may provide functionality for persisting immutable change log records at the charge segment level; implementing discount application logic; implementing the API described in reference to FIG. 2; and supporting change reason codes as part of the change log object schema depicted in FIG. 3.

At a high level, in some embodiments, the metrics service 1006 and the billing service 1008 may constitute a pub/sub architecture, with the billing service 1008 as the producer and the metrics service 1006 as the consumer. More specifically, in some embodiments, the billing service 1008 may be the owner of subscription/charge segment data and may be configured to produce subscription lifecycle events. A subscription lifecycle event can take on any form as long as it serves as a signal to the metrics service 1006. For example, the subscription lifecycle events may be Subscription ObjectChange events. The metrics service 1006 may be a consumer of the subscription lifecycle events. In particular, the metrics service 1006 may ingest the subscription lifecycle events, calculate metrics data from the events, and store the metrics data in one or more data stores, which may be storage provided by a cloud provider. The metrics service 1006 may periodically (or on-demand) push new metrics to the cloud storage. In the scenario that the event payload does not contain enough information, the metrics service 1006 may call the billing service API to enrich the data. In some embodiments, the billing service 1008 may call an API provided by the metrics service 1006 to show subscription and account-level metrics in a user interface (UI) provided by the billing service 1008.

FIG. 10 depicts the migration of historical subscription metrics data from the billing service 1008 to the metrics service 1006. The migration process flow of FIG. 10 may occur in response to the on-boarding of a new tenant, for example, in which case, all existing subscriptions for the tenant may be migrated to the metrics service 1006. At step 1004, a user 1002 may trigger the migration process. Alternatively, the migration process may be automatically trigger such as in response to execution of a script. At step 1010, the metrics service 1006 may request subscription identifiers for the set of subscriptions to be migrated from the billing service 1008. For instance, the metrics service 1006 may make an API call to the billing service 1008. At step 1012, the metrics service 1006 may split the migration job into batches.

The migration process flow of FIG. 10 may then include the following three groups of actions: 1) migration job dispatch 1014, 2) asynchronous calculation of subscription changes between subscription versions 1016, and 3) manual retry of failed jobs 1018. As part of the migration job dispatch 1014, the metrics service 1006 may loop through all batches, which may include calling a batch API of the billing service 1008. The billing service 1008 may, in turn, send an internal message that results in the batch job being sent from the billing service 1008 to the metrics service 1006. As part of the asynchronous calculation of subscription changes between subscription versions 1016, the billing service 1008 may load subscription versions, calculate the delta values between subscription versions, and push the data to the metrics service 1006, which in turn, may ingest the changes. Then, as part of the manual retry of any failed jobs 1018, the metrics service may group all failed items together and call the batch API again as part of the retry process. At step 1020, the user 1002 may query the migration job status.

In some embodiments, when a new subscription is created or amended, the metrics service 1006 may need to be kept in sync with the billing service 1008 through an incremental sync of the latest subscription change. In some embodiments, the billing service 1008 may be responsible for generating the metrics event in response to a subscription change. For instance, when a subscription is changed in the billing service 1008 via a subscribe( )/amend( ) call or the like, a subscription lifecycle event may be generated. In a separate thread, the metrics service 1006 may consume this subscription lifecycle event and call the billing service 1008 to enrich the event and obtain the delta value(s) corresponding to the subscription change. The billing service 1008 may then compare consecutive versions of the subscription to determine the delta value(s) and return subscription change data to the metrics service 1006. The metrics service 1006 may then consume the subscription change data, calculate one or more subscription metrics from the change data, and persist the calculated subscription metrics in data storage. In some embodiments, this step may be idempotent, meaning that only a single metrics record is generated for duplicate events.

In an on-demand request scenario, such as that depicted in FIG. 2, in which a subscription has already been migrated to the metrics service 1006 and an API call is made to the metrics service 1006 constituting a query for subscription metrics via subscription number or account number, the metrics service 1006 may calculate the metrics based on the change log records, without making an API call to the billing service 1008. It should be appreciated that the metrics service 1006 may still query a back-end service such as the billing service 1008 for the change log records or may access the records without having to query the billing service 1008. In those on-demand request scenarios in which the subscription has not yet been migrated to the metrics service 1006, the metrics service 1006 may attempt to poll the subscription data from the billing service 1008, and then calculated the metrics upon receipt of the subscription data. In some embodiments, in one or more of the above-described process flows, an internal API in the billing service 1008 may be called to generate the metrics event, which may involve a function call such as f(subscriptionNumber)→List<SubscriptionChangeRequest>. Given a subscriptionNumber input, this function returns all subscription changes of all versions of the subscription.

In some embodiments, the goal of subscription migration is to generate change log records for all legacy subscription/amendment data. A high-level algorithm for achieving this migration is shown below.

```
  1. For each tenant, get all subscription numbers
  2. for each subscriptionNumber in the list
    2.1. list all charge segments by subscriptionNumber (pagination)
    2.2. group segments by subscription version
    2.3. sort groups by version (old version goes first)
    2.4. For each version, comparing with its previous version(for v1,
null) to generate delta value.
```

In addition, step 2.4 includes in some embodiments:

```
  1. Associate the change reason with the change log
    a. For vl, the ChangeReason is null, means, the segment is created
by a subscribe ( ) call.
    b. For other versions, use ‘ratePlan.subscription.CreatorAmendment’
as the ChangeReason.
  2. Only generate ChangeLog for changes on:
    a. quantity
    b. price
    c. term start/end dates
```

In some embodiments, because the change log records are immutable and each record has a corresponding unique identifier (e.g., key), the migration process is tolerant to duplicate change log records. Moreover, in addition to being tolerant to duplication, the process is also tolerant to disorder because each migration tasks is a self-contained unit that includes the comparison result of two adjacent versions. That is, in some embodiments, the order in which the change log records are ingested does not impact the migration process.

In some embodiments, message loss may occur. To mitigate the risk of message loss, a reconciliation job may be provided to capture missing events. In some embodiments, there may be two types of reconciliations that may be performed: 1) a gross MRR comparison to check data accuracy, and 2) a fix of mismatched records. Example pseudo-code for checking gross MRR and example pseudo-code for fixing mismatched records are respectively provided below.

```
  1. query all RatePlanCharges of subscriptions which have been
updated equal or afterfromTimestamp
  2. Group charges by subscription number
  3. Iterate on subscription number list
    a. Query SegmentChangeLog by subscription number
    b. Sum grossMrr for each charge
    c. Compare sum of gross Mrr of each charge between billing data
and metrics side data(need to filter out the records with null or zero
values)
    d. Any discrepancy between billing and metrics for any given time
span, return a difference object
  4. Return the list of the differences.
```

```
  1. Query all subscription numbers which subscription was updated
within a time period [fromTimestamp, toTimestamp) in Billing
  2. Query all the SubscriptionState with the updatedOn in the same
time period.
  3. Compare the above two list, find the mismatched records (in
Billing, but not in metrics)
  4. Trigger reingestion event for those mismatched records, to
actively pull the changes.
```

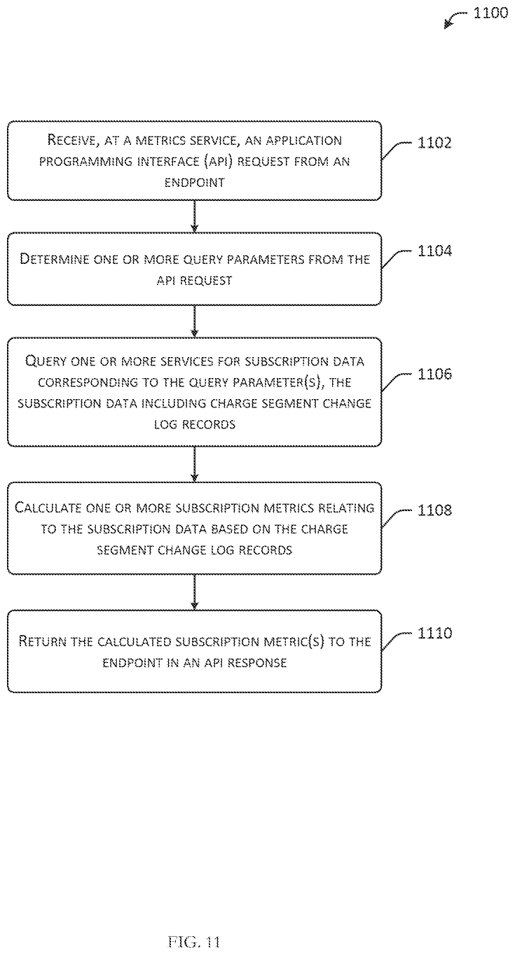

FIG. 11 is a flowchart of an illustrative method 1100 for generating subscription metrics from charge segment change logs in accordance with embodiments of the disclosed technology. The method 1100 will be described in reference to the example embodiment of FIG. 2. At block 1102, the metrics service 208 may receive an API request 204 from an endpoint 202. The API request 204 may be a query by subscription or a query by account for one or more subscription metrics associated with one or more subscriptions.

At block 1104, the metrics service 208 may determine one or more query parameters 206 from the API request 204. The query parameter(s) 206 may include any of the example types of query parameters previously described. At block 1106, the metrics service 208 may query one or more back-end services (e.g., a billing service) to retrieve subscription data corresponding to the identified query parameters 206. The subscription data may include charge segment change log records 220 that reflect amendments/changes made to one or more subscriptions. Alternatively, if the subscription data including the charge segment change log records 220 have already been migrated to the metrics service 208, this step may not be required.

At block 1108, the metrics service 208 may calculate one or more subscription metrics 224 from the charge segment change log records 220. More specifically, in some embodiments, the metrics calculation engine 210 may be executed to generate the subscription metrics 224. In some embodiments, such as those in which some or all of the change log records 220 have not been migrated to the metrics service 208, another service (e.g., a billing service) may calculate the subscription metrics and send them to the metrics service 208, which may ingest and persist them. Then, at block 1110, the metrics service 208 may return the calculated subscription metrics 224 to the endpoint 202 in the API response 222.

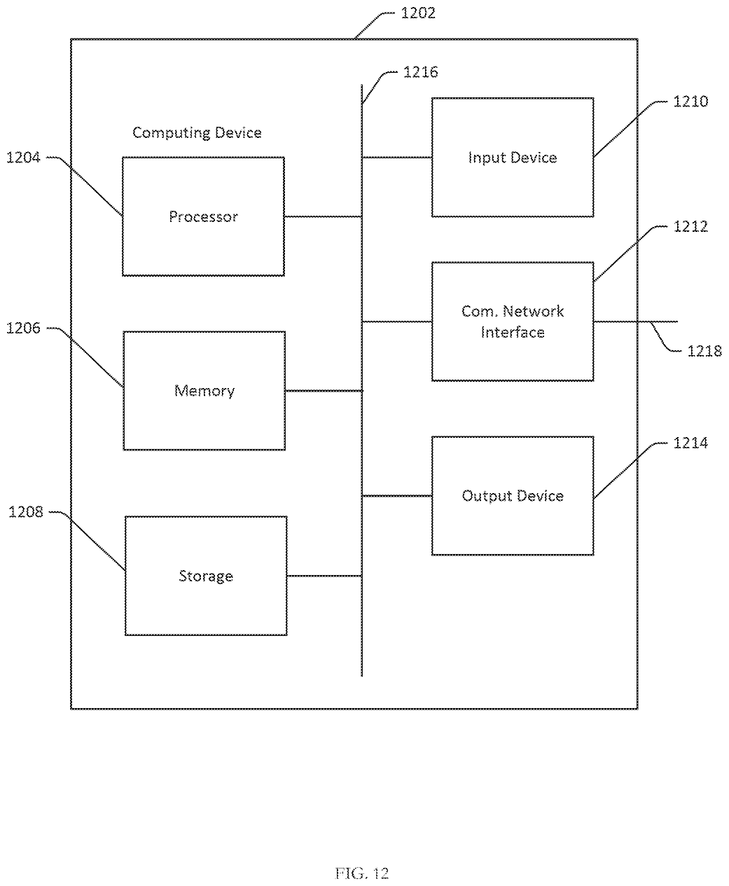

FIG. 12 depicts a diagram of an example of a computing device 1202. Any of the systems, engines, data stores, and/or networks described herein may comprise one or more instances of the computing device 1202. In some embodiments, functionality of the computing device 1202 is improved to the perform some or all of the functionality described herein. The computing device 1202 comprises a processor 1204, memory 1206, storage 1208, an input device 1210, a communication network interface 1212, and an output device 1214 communicatively coupled to a communication channel 1216. The processor 1204 is configured to execute executable instructions (e.g., programs). In some embodiments, the processor 1204 comprises circuitry or any processor capable of processing the executable instructions.

The memory 1206 stores data. Some examples of memory 1206 include storage devices, such as RAM, ROM, RAM cache, virtual memory, etc. In various embodiments, working data is stored within the memory 1206. The data within the memory 1206 may be cleared or ultimately transferred to the storage 1208.

The storage 1208 includes any storage configured to retrieve and store data. Some examples of the storage 1208 include flash drives, hard drives, optical drives, cloud storage, and/or magnetic tape. Each of the memory system 1206 and the storage system 1208 comprises a computer-readable medium, which stores instructions or programs executable by processor 1204.

The input device 1210 is any device that inputs data (e.g., mouse and keyboard). The output device 1214 outputs data (e.g., a speaker or display). It will be appreciated that the storage 1208, input device 1210, and output device 1214 may be optional. For example, the routers/switchers may comprise the processor 1204 and memory 1206 as well as a device to receive and output data (e.g., the communication network interface 1212 and/or the output device 1214).

The communication network interface 1212 may be coupled to a network (e.g., network 108) via the link 1218. The communication network interface 1212 may support communication over an Ethernet connection, a serial connection, a parallel connection, and/or an ATA connection. The communication network interface 1212 may also support wireless communication (e.g., 802.12 a/b/g/n, WiMax, LTE, WiFi). It will be apparent that the communication network interface 1212 may support many wired and wireless standards.

It will be appreciated that the hardware elements of the computing device 1202 are not limited to those depicted in FIG. 12. A computing device 1202 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1204 and/or a co-processor located on a GPU (i.e., NVidia).

It will be appreciated that an “engine,” “system,” “data store,” and/or “database” may comprise software, hardware, firmware, and/or circuitry. In one example, one or more software programs comprising instructions capable of being executable by a processor may perform one or more of the functions of the engines, data stores, databases, or systems described herein. In another example, circuitry may perform the same or similar functions. Alternative embodiments may comprise more, less, or functionally equivalent engines, systems, data stores, or databases, and still be within the scope of present embodiments. For example, the functionality of the various systems, engines, data stores, and/or databases may be combined or divided differently. The data store or database may include cloud storage. It will further be appreciated that the term “or,” as used herein, may be construed in either an inclusive or exclusive sense. Moreover, plural instances may be provided for resources, operations, or structures described herein as a single instance.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, data stores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some embodiments, the processors or processor-implemented engines may be located in a single geographic location (e.g., within a home environment, an office environment, or a server farm). In other embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to embodiments. It will be apparent to those skilled in the art that various modifications may be made and other embodiments may be used without departing from the broader scope of the present invention(s). Therefore, these and other variations upon the embodiments are intended to be covered by the present invention(s).

What is claimed is:

1. A method of generating subscription metrics from subscription data stored in a multi-tenant computing environment, the method comprising:
receiving, at a metrics service of a multi-tenant computing environment, a request from an endpoint;
determining one or more query parameters from the request;
identifying subscription data corresponding to the one or more query parameters, the subscription data including charge segment change log records associated with a subscription charge of a subscription, each charge segment change log record including a delta value indicating an increase or decrease in the subscription charge for a corresponding charge segment time segment;
calculating one or more subscription metrics relating to the subscription data based on the charge segment change log records; and
returning a response to the endpoint that includes the one or more calculated subscription metrics.

2. The method of claim 1, wherein calculating the one or more subscription metrics comprises:
calculating a recurring subscription metric for a particular time segment of the subscription charge, the particular time segment having a duration corresponding to a time period over which the recurring subscription metric is defined.

3. The method of claim 2, wherein calculating the recurring subscription metric for the particular time segment comprises:
identifying each charge segment change log record that corresponds to a respective charge segment time segment that includes the particular time segment;
determining a respective delta value for each identified charge segment change log; and
summing each respective delta value to obtain the recurring subscription metric for the particular time segment.

4. The method of claim 2, wherein the recurring subscription metric is monthly recurring revenue (MRR) and the particular time segment is a particular month of an overall time period during which the subscription is active.

5. The method of claim 1, further comprising:
receiving input indicating an amendment to the subscription;
determining, from the received input, a time period over which the amendment to the subscription is applicable;
determining, from the received input, an amount by which the subscription charge is changed by the amendment; and
generating a new charge segment change log record comprising a corresponding charge segment time segment equal to the time period over which the amendment to the subscription is applicable and a corresponding delta value equal to the amount by which the subscription charge is changed by the amendment.

6. The method of claim 5, wherein the new charge segment change log record further comprises an amendment type field, the method further comprising:
populating the amendment type field with a reason code identifying an attribute of the subscription modified by the amendment to the subscription.

7. The method of claim 6, wherein the amendment to the subscription is a first amendment to the subscription, the new charge segment change log record is a first new charge segment change log record, the reason code is a first reason code, and the attribute of the subscription is a first attribute of the subscription, the method further comprising:
determining that the received input indicates a second amendment to the subscription linked to the first amendment to the subscription;
generating a second new charge segment change log record for the second amendment to the subscription, the second new charge segment change log record comprising the amendment type field; and
populating the amendment type field of the second new charge segment change log record with a second reason code identifying a second attribute of the subscription modified by the second amendment to the subscription, wherein the second reason code is distinct from the first reason code.

8. The method of claim 1, wherein the charge segment change log records associated with the subscription charge are ordered based on respective start dates of the corresponding charge segment time segments.

9. The method of claim 1, wherein identifying the subscription data comprises querying one or more back-end services of the multi-tenant environment for the subscription data.

10. The method of claim 1, further comprising:
determining a gross value of a recurring subscription metric for a particular time segment at least in part by summing a respective delta value of each charge segment change log record corresponding to a respective charge segment time segment that includes the particular time segment;
identifying a first recurring discount and a second recurring discount to be applied to the subscription charge, the first recurring discount having a higher priority of application to the subscription charge than the second recurring discount, the first recurring discount being a fixed amount discount and the second recurring discount being a percentage discount;
determining a first discount value for the particular time segment based on the first recurring discount;
applying, based on the first recurring discount having a higher priority than the second recurring discount, the first recurring discount to the gross value of the recurring subscription metric for the particular time segment to obtain an intermediate value;
applying the second recurring discount to the intermediate value to obtain a second discount value for the particular time segment;
summing the first discount value and the second discount value to obtain a total discount value for the particular time segment; and
subtracting the total discount value from the gross value of the recurring subscription metric to obtain a net value of the recurring subscription metric for the particular time segment.

11. The method of claim 10, wherein the subscription charge is a first subscription charge, the gross value of the recurring subscription metric for the particular time segment is a first gross value corresponding to the first subscription charge, the net value of the recurring subscription metric for the particular time segment is a first net value corresponding to the first subscription charge, and the subscription includes a second subscription charge, the method further comprising:
determining that the first recurring discount is exhausted after determining the first discount value for the particular time segment for the first subscription charge; and
applying only the second recurring discount to a second gross value of the recurring subscription metric corresponding to the second subscription charge for the particular time segment to obtain a net value of the recurring subscription metric corresponding to the second subscription charge for the particular time segment.

12. The method of claim 1, further comprising:
converting the charge segment change log records into corresponding metrics segments;
generating a first visualization of the charge segment change log records, the first visualization including a graphical depiction of a respective delta value of each charge segment change log record extending across a respective charge segment time segment of the charge segment change log record; and
generating a second visualization of the metrics segments, the second visualization including a graphical depiction of a respective value of a recurring subscription metric for each of multiple time segments that cumulatively span an overall time period during which the subscription is active.

13. A system of generating subscription metrics from subscription data stored in a multi-tenant computing environment, the system comprising:
at least one memory storing computer-executable instructions; and
at least one processor configured to access the at least one memory and execute the computer-executable instructions to:
receive request from an endpoint;
determine one or more query parameters from the request;
retrieve subscription data corresponding to the one or more query parameters, the subscription data including charge segment change log records associated with a subscription charge of a subscription, each charge segment change log record including a delta value indicating an increase or decrease in the subscription charge for a corresponding charge segment time segment;
calculate one or more subscription metrics relating to the subscription data based on the charge segment change log records; and
return a response to the endpoint that includes the one or more calculated subscription metrics.

14. The system of claim 13, wherein the at least one processor is configured to calculate the one or more subscription metrics by executing the computer-executable instructions to:
calculate a recurring subscription metric for a particular time segment of the subscription charge, wherein the particular time segment has a duration corresponding to a time period over which the recurring subscription metric is defined.

15. The method of claim 14, wherein the at least one processor is configured to calculate the recurring subscription metric for the particular time segment by executing the computer-executable instructions to:
identify each charge segment change log record that corresponds to a respective charge segment time segment that includes the particular time segment;
determine a respective delta value for each identified charge segment change log; and
sum each respective delta value to obtain the recurring subscription metric for the particular time segment.

16. The system of claim 12, wherein the at least one processor is further configured to execute the computer-executable instructions to:
receive input indicating an amendment to the subscription;
determine, from the received input, a time period over which the amendment to the subscription is applicable;
determine, from the received input, an amount by which the subscription charge is changed by the amendment; and
generate a new charge segment change log record comprising a corresponding charge segment time segment equal to the time period over which the amendment to the subscription is applicable and a corresponding delta value equal to the amount by which the subscription charge is changed by the amendment.

17. The system of claim 16, wherein the new charge segment change log record further comprises an amendment type field, and wherein the at least one processor is further configured to execute the computer-executable instructions to:
populate the amendment type field with a reason code identifying an attribute of the subscription modified by the amendment to the subscription.

18. The system of claim 17, wherein the amendment to the subscription is a first amendment to the subscription, the new charge segment change log record is a first new charge segment change log record, the reason code is a first reason code, and the attribute of the subscription is a first attribute of the subscription, and wherein the at least one processor is further configured to execute the computer-executable instructions to:
determine that the received input indicates a second amendment to the subscription linked to the first amendment to the subscription;
generate a second new charge segment change log record for the second amendment to the subscription, the second new charge segment change log record comprising the amendment type field; and
populate the amendment type field of the second new charge segment change log record with a second reason code identifying a second attribute of the subscription modified by the second amendment to the subscription, wherein the second reason code is distinct from the first reason code.

19. The system of claim 13, wherein the at least one processor is further configured to execute the computer-executable instructions to:
determine a gross value of a recurring subscription metric for a particular time segment at least in part by summing a respective delta value of each charge segment change log record corresponding to a respective charge segment time segment that includes the particular time segment;
identify a first recurring discount and a second recurring discount to be applied to the subscription charge, the first recurring discount having a higher priority of application to the subscription charge than the second recurring discount, the first recurring discount being a fixed amount discount and the second recurring discount being a percentage discount;
determine a first discount value for the particular time segment based on the first recurring discount;
apply, based on the first recurring discount having a higher priority than the second recurring discount, the first recurring discount to the gross value of the recurring subscription metric for the particular time segment to obtain an intermediate value;
apply the second recurring discount to the intermediate value to obtain a second discount value for the particular time segment;
sum the first discount value and the second discount value to obtain a total discount value for the particular time segment; and
subtract the total discount value from the gross value of the recurring subscription metric to obtain a net value of the recurring subscription metric for the particular time segment.

20. The system of claim 19, wherein the subscription charge is a first subscription charge, the gross value of the recurring subscription metric for the particular time segment is a first gross value corresponding to the first subscription charge, the net value of the recurring subscription metric for the particular time segment is a first net value corresponding to the first subscription charge, and the subscription includes a second subscription charge, the method further comprising:
determining that the first recurring discount is exhausted after determining the first discount value for the particular time segment for the first subscription charge; and
applying only the second recurring discount to a second gross value of the recurring subscription metric corresponding to the second subscription charge for the particular time segment to obtain a net value of the recurring subscription metric corresponding to the second subscription charge for the particular time segment.

21. A method of storing subscription data in a multi-tenant environment, the method comprising:
receiving input indicating a change to a recurring subscription charge for a subscription;
determining, from the received input, a time period over which the change to the recurring subscription charge is applicable;
generating a charge segment change log record representative of the change to the recurring subscription charge, the charge segment change log record including a charge segment time segment corresponding to the time period over which the change to the recurring subscription charge is applicable and a delta value corresponding to an amount of the change to the recurring subscription charge; and
appending the charge segment change log record to an existing set of one or more stored change log records associated with the subscription charge, the set of charge segment change log records including the appended charge segment change log record occupying less data storage capacity than a set of subscription versions, each subscription version representing a current state of the subscription after a corresponding change to the subscription and each prior state of the subscription.
